(19) United States
(12) Patent Application Publication
(10) Pub. No.: US 2003/0172025 A1
(43) Pub. Date: Sep. 11, 2003

(54) Computerized system and method for qualifying mortgage loan clients

(76) Inventor: Mike A. Gallina, Covina, CA (US)

Correspondence Address: Richard C. Litman, LITMAN LAW OFFICES, LTD., P.O. Box 15035, Arlington, VA, 22215, US

(21) Appl. No.: 10/361,149

(22) Filed: Feb. 10, 2003

Related U.S. Application Data
(60) Provisional application No. 60/354,511, filed on Feb. 8, 2002.

(51) Int. Cl. G06F 17/60

(52) U.S. Cl. 705/38

(57) ABSTRACT

A computerized system and method for qualifying mortgage loan clients over the Internet. The invention uses client-server technology to allow a designated broker and client to qualify for conventional and non-conventional sources of mortgage loans. The computerized system is tied into credit bureaus, title companies and borrower and seller public records and combines this information with client-entered data on a matrix or smart loan application. The matrix and smart loan application are color coded for easy understanding and cross-references all of the client's data with the investors' underwriting guidelines. Provisions for unsuccessful approval attempts are followed up with corrective action and successful approval attempts are supplemented with specific options and terms.

### CROSS-REFERENCE TO RELATED APPLICATION

This application claims the benefit of U.S. Provisional Patent Application Serial No. 60/354,511, filed Feb. 8, 2002.

### BACKGROUND OF THE INVENTION

1. Field of the Invention

The present invention relates to a computerized system and method for qualifying mortgage loan clients.

2. Description of Related Art

The mortgage loan business is an important one, which allows individuals to become homeowners and get a piece of the American dream. The mortgage loan business must accommodate a wide range of clients with a wide range of creditworthiness. Some clients will have perfect credit while some clients will have a less than perfect credit record or even poor credit. A good mortgage broker must be able to handle and assist persons with all types of credit.

Mortgage loan patents are prevalent in the related art. U.S. Pat. No. 4,876,648 issued to Lloyd, describes the use of a computerized mortgage implementing system, which includes a central service computer, which helps establish and maintain mortgage plans based upon mortgages that are at least partially collateralized by investment vehicles. Both a plurality of groups of investment vehicle information and mortgage information are stored in a service computer.

U.S. Pat. Nos. 5,611,052, 5,930,776 and 6,029,149 issued to Dykstra et al., describe apparatuses and methods for automatic credit evaluation and loan processing. The apparatuses, includes central processing units which have capabilities for communicating with off-site remote access terminals. The central processing units also include facsimile transmission capabilities as well as capabilities for communicating with credit bureau computers. Mass storage capabilities are included for storing program modules executable on the central processing units and for maintaining databases.

U.S. Pat. No. 5,644,726 issued to Oppenheimer, describes a process and-method of financing the purchase of real property by mortgagors through a combination of mortgagee debt principal and partial mortgagee equity interest in the purchased property by a system which both calculates multiple mortgagor financial obligations and mortgagee rights and which prints instruments embodying those obligations and rights.

U.S. Pat. No. 6,088,686 issued to Walker et al., describes a real-time, on-line computerized system that streamlines the processing of applications for products and services offered by a financial institution. The system automates many steps in the credit and liability review and approval process, performs background credit worthiness evaluations based upon an applicant's credit score, financial information and new and existing relationship with the financial institution.

U.S. Pat. No. 6,269,347 issued to Berger, describes a method for calculating a mortgage, which provides application of mortgage payments to principal first and then interest in the amortization schedule of repayment of a conventional loan. The disclosure provides a method for calculating mortgage payments on a conventional mortgage loan by applying such payments first to a reduction of principal while accumulating accrued interest. Payments are applied toward accrued interest after the principal amount of the loan is reduced.

Although each of the patents described involve valuable and important systems and methods, what is really needed is an automated and comprehensive system and method for processing a mortgage loan application over the Internet. Such a system and method should be able to handle clients with a wide range of creditworthiness and address the needs of clients with poor credit.

None of the above inventions and patents, taken either singly or in combination, is seen to describe the instant invention as claimed.

### SUMMARY OF THE INVENTION

The invention is a computerized system and method for qualifying mortgage loan clients over the Internet. The invention uses client-server technology to allow a designated broker and client to qualify for conventional and unconventional sources of mortgage loans. The computerized system is tied into credit bureaus, title companies and borrower and seller public records and combines this information with client-entered data on a matrix or application. The matrix and application are color coded for easy understanding and cross-references all of the client's data with the investors' underwriting guidelines. Provisions for unsuccessful approval attempts are followed up with corrective action and successful approval attempts are supplemented with specific options and terms.

Accordingly, it is a principal object of the invention to quickly and accurately qualify mortgage loan clients.

It is another object of the invention to provide cost effective training to new mortgage loan officers.

It is a further object of the invention to provide problem solving capabilities and options for mortgage loan clients.

Still another object of the invention is to introduce a client to conventional and unconventional financing options.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview of a computerized system for qualifying mortgage loan clients according to the present invention.

FIG. 2 is a flowchart showing the steps performed by the software for qualifying mortgage loan clients.

FIG. 3 is a screenshot of an example of a client with good creditworthiness.

FIGS. 4A-4B are screenshots of an example of a client with average creditworthiness.

FIGS. 5A-5B are screenshots of an example of a client with poor creditworthiness.

FIG. 6A is a chart showing principal and interest payments for a variety of fee options and terms.

FIG. 6B is a chart showing the total interest and monthly payments for a variety of terms for a $150,000 loan at 6.625%.

FIG. 7 is a broker services high-level flow sheet for the IP database and the QM database.

FIG. 8 is a screenshot of the broker underwriting criteria search function.

FIG. 9 is a screenshot of the broker case study function.

FIG. 10 is a screenshot of the auto rate lock function.

FIG. 11 is a screenshot of the broker's favorite vendors list function.

FIGS. 12A-12H are screenshots of the borrower's profile electronic submission interface function.

FIGS. 13A-13I are screenshots of the credit functions module.

FIGS. 14A-14G are screenshots and a flow diagram of the smart loan application.

FIGS. 15A-15K are screenshots of the transaction analyzer function.

FIG. 16 is an investor services high-level flow sheet diagram for the IP database.

FIGS. 17A-17E are screenshots of the rate and fee price loading function.

FIGS. 18A-18C are flow diagrams of the program loading logic.

FIGS. 19A-19Q are screenshots of the IP pre-loading submodule.

FIGS. 20A-20B are screenshots of the impound schedules load.

FIGS. 21A-21E are screenshots of electronic submission and approval documents.

Similar reference characters denote corresponding features consistently throughout the attached drawings.

### DETAILED DESCRIPTION OF THE PREFERRED EMBODIMENT

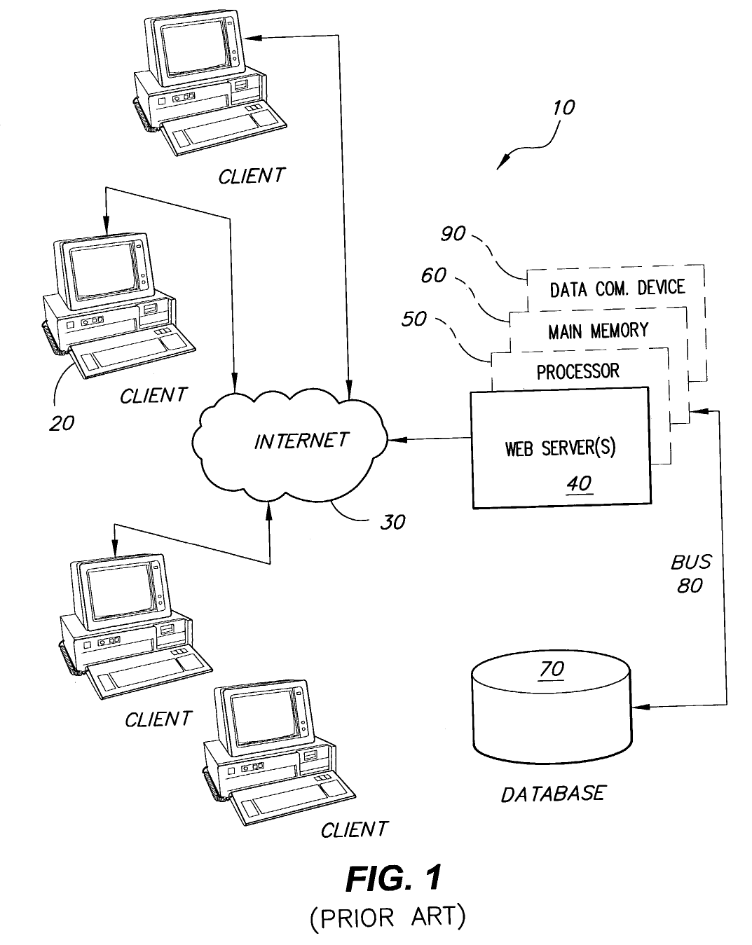

The present invention is a computerized system 10, in which the present invention operates, as shown in FIG. 1. The computerized system 10 uses a client-server model, including a plurality of clients 20 connected to a Web server 40 through a computer network, preferably the Internet 30, although the computerized system 10 may operate on an intranet or extranet. The Web server 40 has a processor 50 for processing instructions and an area of main memory 60 for executing program code under the direction of the processor 50 connected by a bus 80.

The computerized system 10 also includes at least one relational database 70 for storing data. The relational database(s) 70 may reside in an area of disk storage on the Web server 40 and be connected to the main memory by the bus 80, or may reside on a remote database server accessible by the Web server 40, as is known in the art. A data communications device 90 is connected to the bus 80 for connecting the Web server 40 to the Internet 30. The client computers 20 have a Web browser operable thereon for receiving and viewing documents written in Hypertext Markup Language (HTML) and transmitted over the Internet 30 via Hypertext Transfer Protocol (HTTP) by the Web server 40 and transmitting requests for HTML documents to the Web server 40 via HTTP.

The present invention includes software program code stored on a computer readable medium and is operable in main memory on the Web server 40 for qualifying mortgage loan clients, which is accessible to a client computer 20 through the Internet 30. As used in the present application, the term “computer readable medium” refers to a hard disk drive, a floppy diskette, a ZIP disk or any other magnetic storage media capable of storing coded program instructions, an optical or laser storage device, such as a compact disk, laser disk, paper tape, punch cards or any other media for the storage of program instructions readable by a disk storage device or reader.

The computer code may be written in Java□ (Java is a trademark of Sun Microsystems), HTML, XML or Microsoft's Active Server Pages (ASP), and includes code for qualifying mortgage loan clients, as well as illustrating Web pages, where a qualifying mortgage loan matrix or loan application is produced and shows underwriting conditions for clients with a wide range of creditworthiness from both conventional and non-conventional investors. The computer software will not actually load into a client computer or be disseminated in any way other than being accessed at the Web site, with the exception of a software patch, which is used as part of the invention.

A Web-based qualifying mortgage loan computer program code is in the storage device and executes in the main memory 60 under the direction of the processor 50. The computer program includes a Web server software means for qualifying mortgage loan clients for at least one Web site on the Internet 30, for receiving a client's data from a client through the Web site, for requesting client data from a plurality of title companies 100 and a plurality of credit bureaus 110, for indicating which client data has good creditworthiness, average creditworthiness and poor creditworthiness and for making a mortgage loan approval attempt using conventional investors and non-conventional investors, for indicating the type of mortgage loan program desired and indicating if investors' standards are met, for indicating the best mortgage loan programs and options available and for rejecting the application of a mortgage loan program and taking corrective action.

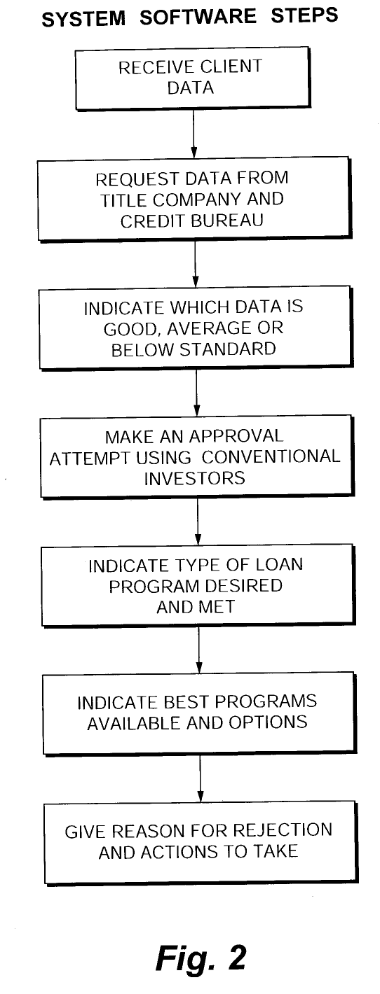

FIG. 2 outlines the steps and calculations that the computer program means actually performs. The first step includes a Web server software means for qualifying mortgage loan clients on at least one Web site on the Internet 30. Typically a broker will be given an authorization number, which the broker can use to log on to the Web site, which is at a specific Web address. This identifies to the computerized system 10 that the broker is an authorized user. This is also technology that is well known to those schooled in the related art.

The broker is assisted by his client to enter his client's basic identifying information, so the computerized system 10 can access and perform the next step, which is requesting client data from a plurality of title companies 100 and a plurality of credit bureaus 110. The computerized system 10 links to a plurality of title companies 100 and credit bureau 110 databases from Web server to Web server over the Internet 30 and draws up additional client information and auto populates this data into a matrix questionnaire 120. The computerized system 10 also verifies the initial basic identifying information given to the computerized system 10. The computerized system 10 also searches borrower and seller public records to confirm client judgments, marriages, child support, liens and Lis Pendens.

The computerized system 10 gives each investor only the particular credit bureaus 110 and title companies 100 they require to qualify for a loan in the format they choose. Note that different investors have different criteria for this information. For example, some investors want only Trans-Union and not Experian and Equifax credit reports. Many want all three credit bureaus while some may only want two. Some investors require an average of all three scores, some only want one particular score depending on the borrower's zip code. The computerized system 10 will provide the data in the exact format that each individual investor requests.

The client data is then auto populated into a matrix questionnaire 120 that cross-references the conventional and non-conventional investors and questions answered from the client. The computerized system 10 considers conventional Freddie Mac and Fannie Mae financing, Federal Housing Administration (FHA) and Veterans Administration (VA) financing to be conventional investor financing. All other investor financing, such as sub-prime rate financing, 100% financing (without any down payment) and customized financing (or “stated financing”) are considered to be non-conventional investor financing and are categorized as portfolio loans.

The broker and client then complete the remaining questions from the matrix questionnaire 120 manually. When the questions are completed, the matrix questionnaire 120 appears and the means for requesting client data are color coded to indicate the individual loan parameter's creditworthiness. Green colored sections of the matrix questionnaire 120 show information that is considered to have good creditworthiness and is at a good standard. Yellow colored sections of the matrix questionnaire 120 show information that is considered to have average creditworthiness and is at an average standard. Red colored sections of the matrix questionnaire 120 show information that is considered to have poor creditworthiness and is at a poor standard.

At this time, the broker and client can begin problem solving and manipulating data discerning the path of least resistance for a loan approval if the matrix questionnaire 120 indicates a decent chance of an approval. The broker and client can then click on specific client data to bring up sub-pages, wherein client data with average creditworthiness and poor creditworthiness are provided with underwriting guidelines and case studies to enhance client problem solving. This is an important feature and capability of the computerized system 10 discussed later in this section.

Once problem solving has been done, the broker and client are in a position to make a first approval attempt. The computerized system 10 now engages a search engine lining up the client's actual data against all of the investor's program information. This investor's program information includes all of the investor's particular underwriting criteria. Note that each investor has his own particular interpretations of the conventional investors, so some particular criteria that does not have an average or good standard with one investor, may be considered to have an average or good standard with another investor. This first attempt is made only on conventional investors for this premium type of financing. This means that all clients must first investigate and inquire about conventional investors first and go to the unconventional financing only after the conventional investors have been tried.

The computerized system 10 requires that the highest possible percentage of the client data must match with an investor's investor program information in order to be a successful match. The computerized system 10 also indicates an unsuccessful match where less than the highest possible percentage of the client data matches with an investor's program information. If successful, the broker and client can choose any number of investors that were matches. At this point, a more detailed matrix 130 is provided for exact underwriting guidelines and criteria.

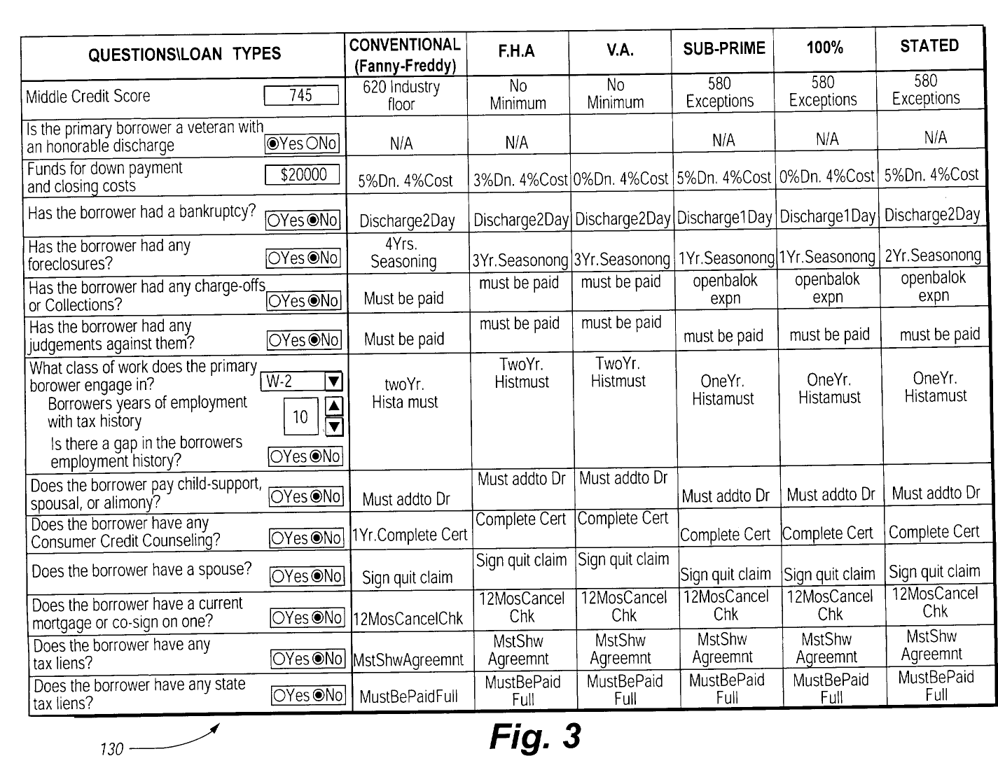

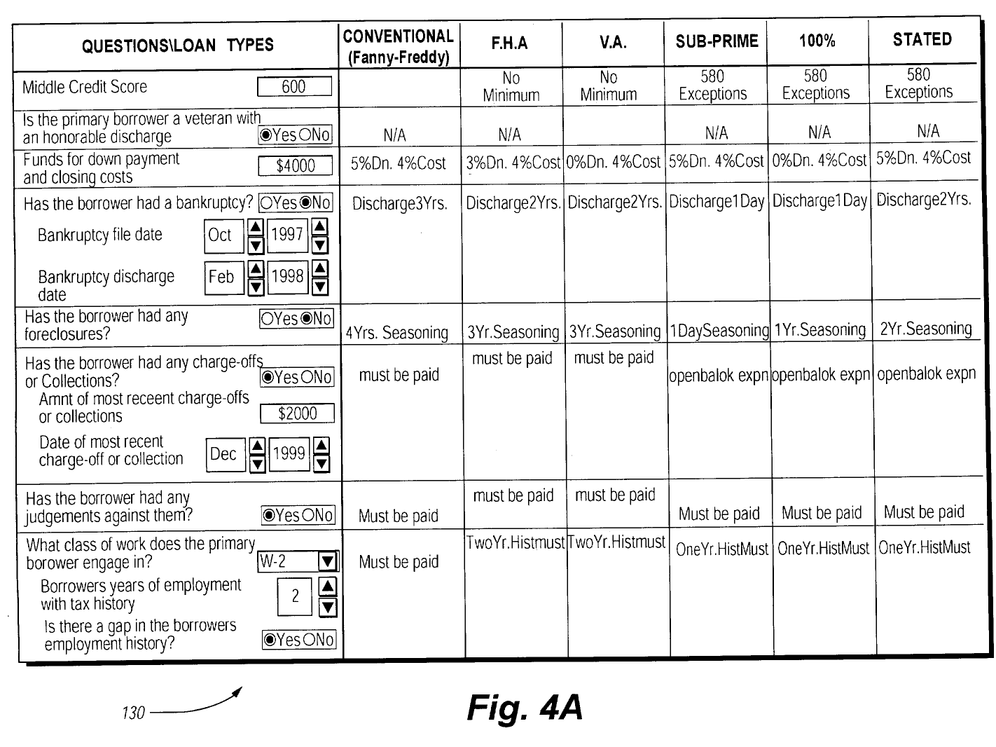

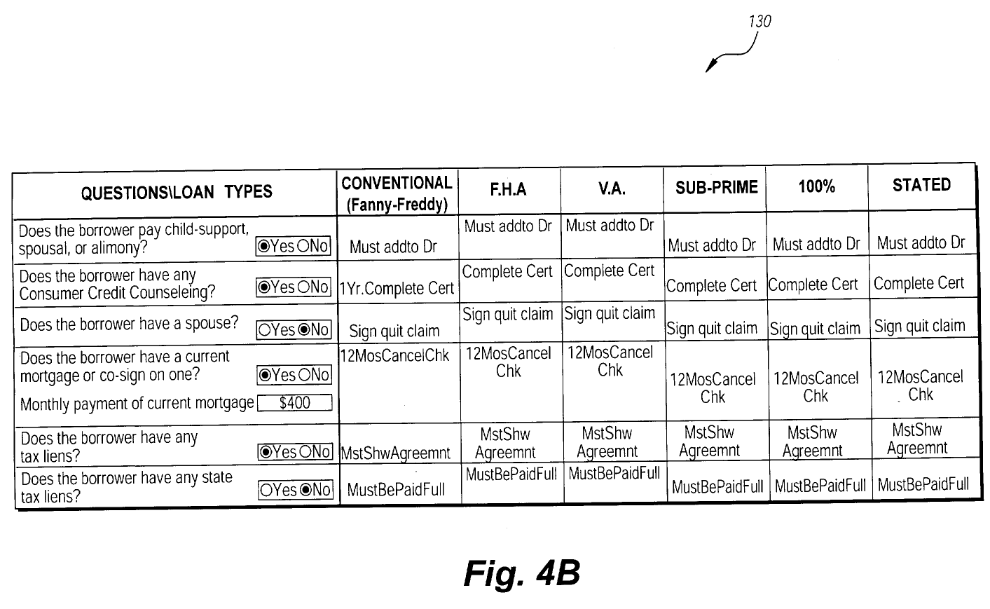

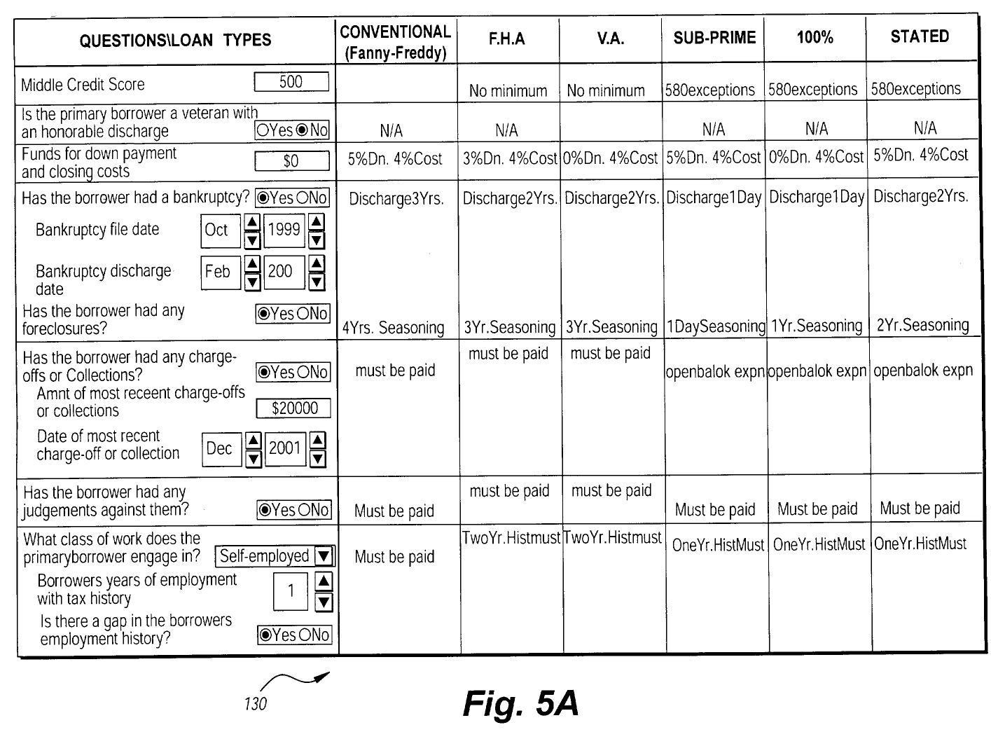

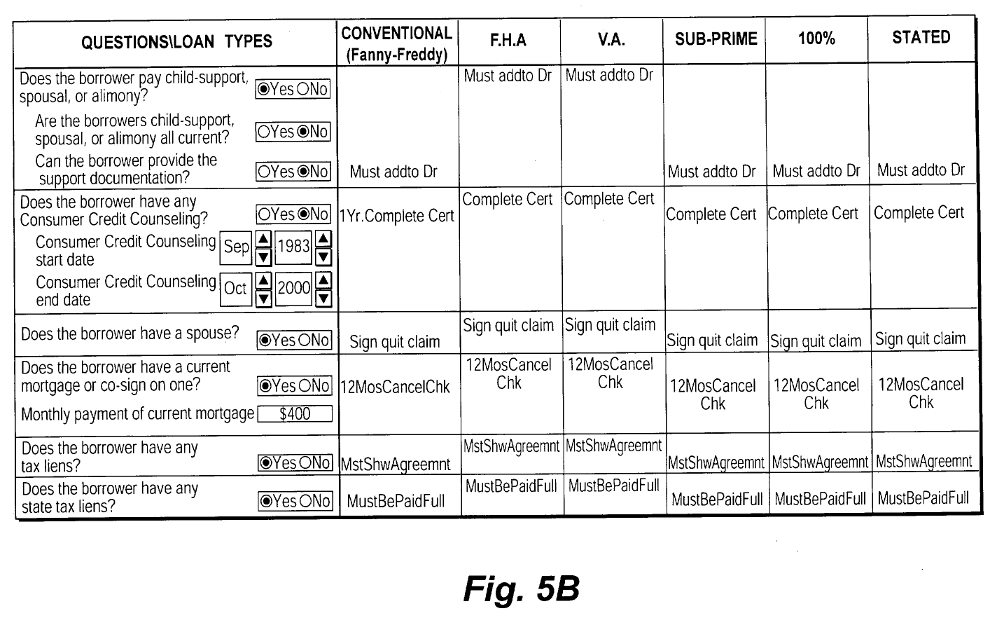

Examples of these detailed matrixes 130 are shown in FIG. 3, FIGS. 4A-4B and FIGS. 5A-5B. FIG. 3 depicts a matrix 130 for a client with good creditworthiness at a good standard throughout the detailed matrix 130. Question details are relatively short and favorable and can be answered mostly with a yes or no response. FIGS. 4A-4B and FIGS. 5A-5B depict larger matrixes 130 because their client's creditworthiness is less than favorable and must be described in more detail for an evaluation. FIGS. 4A-4B depict a matrix 130 for a client with an overall average creditworthiness, with a mix of good, average and poor standards and FIGS. 5A-5B depict a detailed matrix 130 for a client with an overall poor creditworthiness, with primarily poor standards.

The detailed matrix 130 will utilize the same color coding that the matrix questionnaire 120 uses to show creditworthiness, but will utilize underwriting guidelines directly out of the investors' underwriting books within the detailed matrix 130. There will also be case studies to give brokers and clients ideas of how to get past underwriting hurdles as well as actual suggestions from the underwriters of acceptable alternatives and ideas that are guaranteed to be acceptable to the investor and the investor's underwriter. The broker and client can also communicate with an underwriter for clarification via e-mail.

If the broker and client are unsuccessful with their first approval attempt, the computerized system 10 will give the reason for the rejection and suggest the corrective action needed to qualify for the desired loan. If unsuccessful due to credit balances on collection judgments, title company data 100 or credit bureau information 110, the computerized system 10 will find, qualify and arrange for a signature loan to clear bad debt for the client. The computerized system 10 also instantly creates dispute letters for incorrect credit information and direct links to credit bureau servers.

The computerized system 10 automatically e-mails the client's creditors that have disputes with the client (with documentation if needed). An outside facilitator company 160 can intervene to negotiate settlements between the client and the client's creditors. The outside facilitator company 160 strives to obtain release of judgment letters and other related documentation for a fee. If the client is still declined, the client's data is stored for a mail and follow-up campaign.

A transaction coordinator 170 is an important part of the computerized system 10. The transaction coordinator 170 will automatically e-mail all parties transaction access codes and they will be asked to update and review progress on it. There will be a software patch created for vendors to use for downloading critical data and information. This will include escrow, title, inspectors and other professionals involved that will be able to download critical data to their own current software programs. These professionals will be required to pay a fee for the convenience of being able to instantly download desired data.

The computerized system 10 also has predetermined closing schedules. These schedules give a closing plan and can flex and change for longer or shorter escrows. The user will enter the desired escrow period and the computerized system 10 will make the schedule fit the given escrow period.

After final investor approval, an electronic approval is transmitted with an identifying number at this point in time. Investor's required documents are downloaded to the broker and are printed out for broker and client to sign. This is put in a messenger bag and is shipped back to the investor along with the electronic approval needed for the investor's quality control. This is in addition to the letters generated by the computerized system 10 for the client and e-mail directed to the broker explaining the transaction as it proceeds.

If a client is declined, the computerized system 10 will give the client instructions and actions that are needed to qualify. If declined for a time sensitive reason, such as required seasoning on a bankruptcy, the computerized system 10 will e-mail the broker at the correct follow up time. For example, a client must have two years seasoning on his bankruptcy and at his time of application, he has only 18 months. The computerized system 10 will e-mail the broker 6 months from the time of application, just before the seasoning requirement will be satisfied to follow up and begin to reapply. This is discussed in more detail later in this section.

The computerized system 10 also has an automatic default into effect on all loan applications that cannot be placed immediately at their first submission. The computerized system 10 will automatically resubmit any unsuccessful applications into the computerized system 10, searching all investor programs in the computerized system 10, including all conventional and portfolio (unconventional) investor programs until a match is found. The computerized system 10 will also e-mail the broker upon a discovery of a program that fits the client's criteria.

The computerized system 10 can also calculate total remaining interest on all revolving and installment debt. This is an important feature of the computerized system 10 and shows the total savings obtainable with any debt consolidation. Broker statistics will also be kept by the computerized system 10 to track conversion ratios and indicate areas of performance improvement. Statistics include the number of applications taken, the number of electronic approvals, the average escrow period, the number of escrows opened and closed per month, as well as calculating the number of referrals received and the number of repeat clients. An exact closing costs system is also provided to calculate exact closing costs involved with an application.

The computerized system 10 automatically calculates price adjustments such as loan to value, middle credit score and cash out fees. These adjustments are extremely important and there are usually at least 4 or 5 such variables in a loan application and can be as many as 15 or 20 variables. Unfortunately, brokers routinely miss these adjustments causing pricing misquotes. Either the broker has to absorb these costs or the borrower is subjected to these human error costs.

Once the detailed matrix 130 is filled with client data, the broker and client choose what type of mortgage loans they want. These types of mortgage loans are for purchases, refinancing and junior financing. A mini questionnaire (not shown) is generated that asks specific questions to determine the type of financing situation that applies to the client. The client is asked how long he plans on staying on the property and whether he would like a fixed rate or variable rate loan. The client is also asked if he would like a 0 down-payment loan and if he would like to pay off the loan early.

If a client is interested in a refinancing or junior financing, he is asked if he has any additional debt that he would like to include in the loan from credit cards, student loans and taxes. The client is also asked if there are any home improvements that he would like to finance through the loan or if there are any reasons he would like to take any cash out.

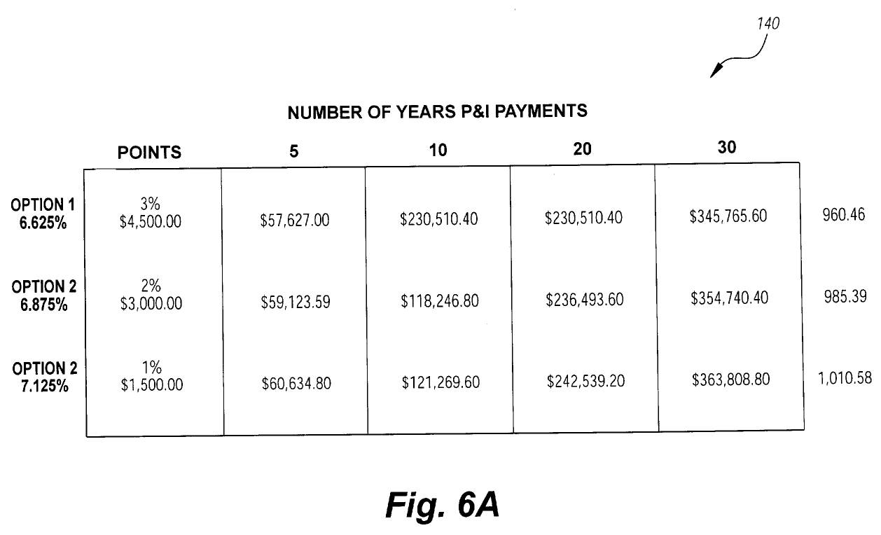

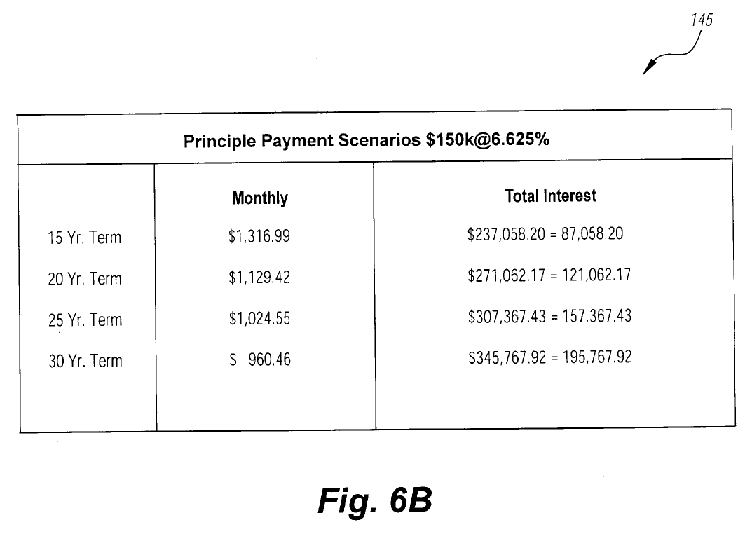

The client then goes to an options page and chooses a specific program. The client would then choose a fee option and a term. An outline of all of the possible fee options and term scenarios is then charted for the client. Options include 1-2-3 fee option loan points with 5, 10, 20 and 30 year terms. FIG. 6A depicts an example of these fee options and terms in a convenient and easy to use chart 140 depicting the difference in the amount of interest and principal paid for each option and terms. A more detailed discussion regarding fee options and terms is provided later in this section.

FIG. 6B is a chart 145 showing an example of the total interest and monthly payments for a variety of terms for a $150,000 loan at 6.625%. Notice the staggering difference in total interest between the 15 year term and the 30 year term ($87,058.20 versus $195,767.92). The differences in monthly payments are also shown for 15 year, 20 year, 25 year and 30 year terms.

A computerized method (FIG. 2) for qualifying mortgage loan clients over the Internet 30 is easy to use and is straightforward. The steps of this computerized method comprises the steps of receiving the client's data from the client through a Web site, requesting client data from a plurality of title companies and a plurality of credit bureaus, indicating which client data has good creditworthiness, average creditworthiness and poor creditworthiness, making a mortgage loan approval attempt using conventional investors and non-conventional investors, indicating the type of mortgage loan program desired and indicating if investors' standards are met, indicating the best mortgage loan programs and options available and rejecting an application of the mortgage loan program and developing further corrective actions to take.

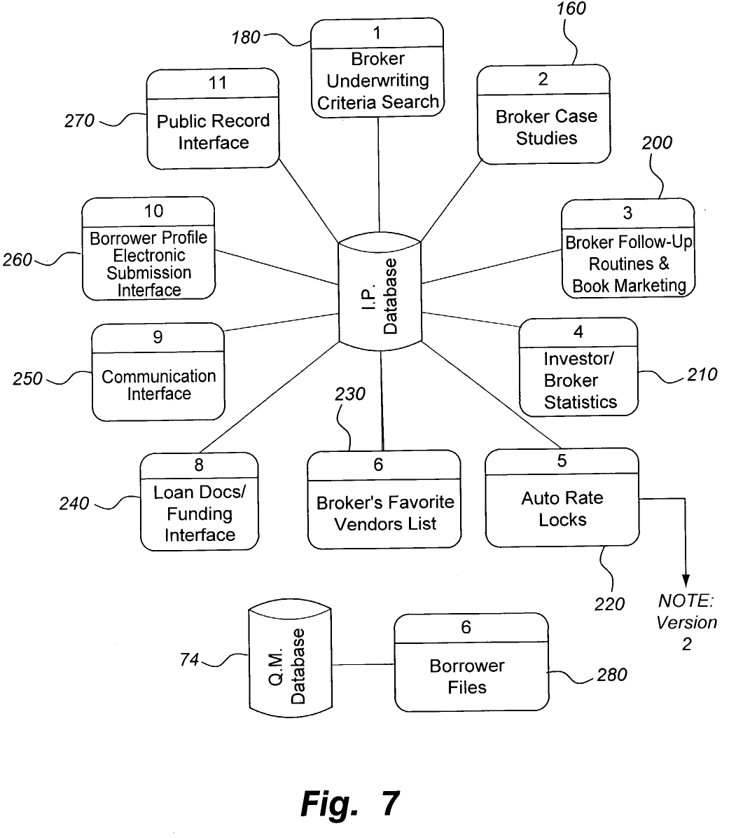

FIG. 7 depicts and overviews the two relational databases involved in assisting brokers, an investor profile database 72 and a questionnaire module database 74. The investor profile database 72 utilizes broker underwriting criteria search capability 180, broker case studies 190, broker follow-up routines and book marketing 200, investor/broker statistics 210, an auto rate lock capability 220, a broker's favorite vendors lists feature 230, loan documents and a funding interface 240, a communication interface 250, a borrower profile electronic submission interface 260 and a public record interface 270. The questionaire module database 74 only utilizes borrowers' files 280.

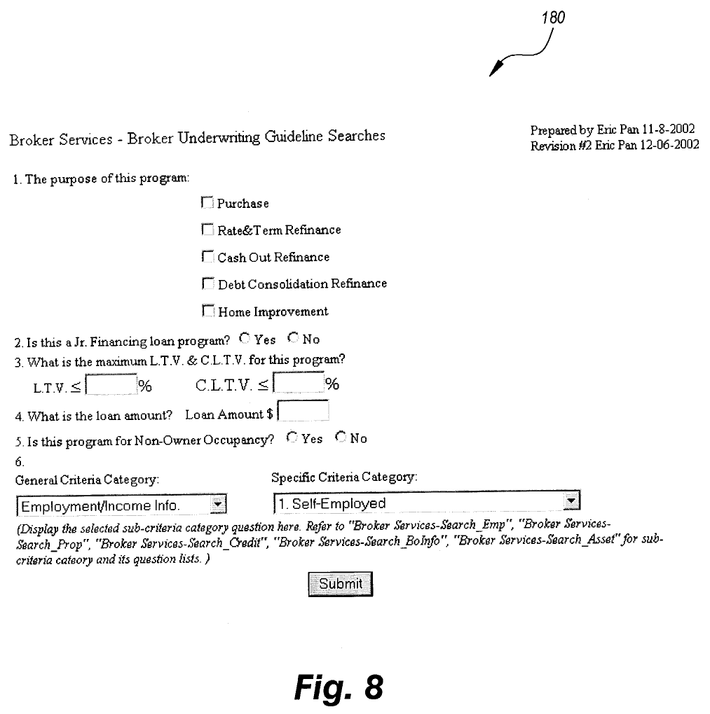

FIG. 8 depicts a Web screen that can perform a broker underwriting criteria search 180. The broker underwriting criteria search 180 allows a broker to search for specific underwriting guidelines in the investor profile database 72. The search is made by first using investor profile sub-modules narrowed by bringing up a menu of the sub-module chosen field names for selection. The broker can then search for investors to accommodate a borrower's special loan requirements. For example, a borrower with a limited employment history might be searched by a broker to find investors willing to accept the borrower's limited employment seasoning to place a loan. The broker underwriting criteria search 180 can save brokers time searching for suitable investors to match their borrower's particular needs. The broker underwriting criteria search 180 can also be used to help borrowers locate financing through their broker, as well as helping investors write more loans by brokers being able to find them.

FIG. 9 depicts broker case studies 190 that use the same logic as the broker underwriting criteria search 180. The broker can search using the same search engine described in FIG. 8, but view similar case studies of other broker's. The broker's case studies 190 display the particular criteria the broker is searching for and how another broker was able to deal with the same issue and work around it. The broker case studies 190 are extremely helpful for problem solving for new and seasoned loan officers and brokers. Also this feature is an excellent training tool for new loan officers and brokers.

The broker case studies 190 search the investor profile database 72 of possible solutions to specific criteria issues loaded by seasoned experience brokers and loan officers. The broker case studies 190 allow brokers to locate investors that may be willing to do a loan with a special criteria issue, as well as train new brokers and loan officers for ways to successfully work around and solve lending issues for borrowers. The broker case studies 190 can save managing brokers time and money on training costs by eliminating the need to personally teach new hires, as well as allow hundreds and thousands of brokers and loan officers to share problem solving logic for free.

The computerized system 10 also utilizes a broker follow-up routine and book marketing module 200 to assist brokers with follow-up and staying in contact with new borrowers and past clients. One feature of this module is it will remind the broker when qualifying dates come up for their borrowers. This will result in increased broker income and help borrowers to remember their qualifying dates. The computerized system 10 also has an investor broker statistic module 210 that keeps statistics on all investors for the broker to review. Statistics will be kept on such items as underwriting and funding times. This data can help the broker to choose the best possible investor to work with, all other things being equal, resulting in saving broker time in choosing correct investors and saving borrower time in a more effective estimated closing date.

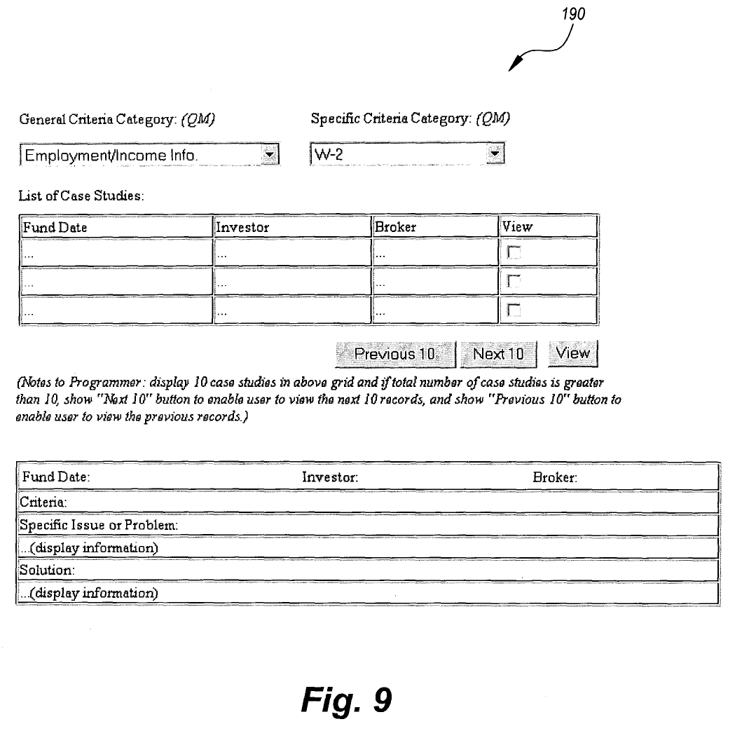

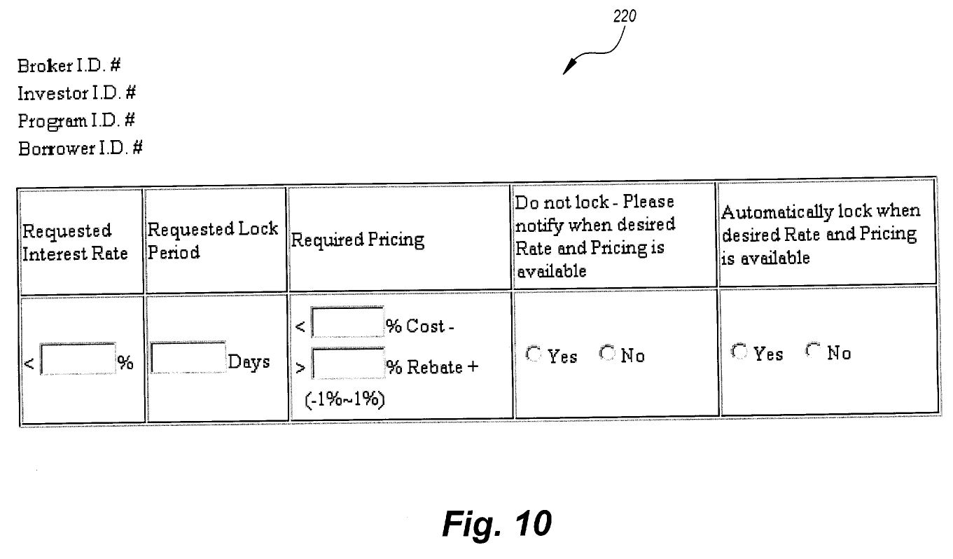

There is also an auto rate lock module 220 with this computerized system 10, as is depicted in FIG. 10. This function will allow the broker to automatically lock a rate for a borrower when the desired rate becomes available or receive a notification of an available rate for any borrower in the broker database (not shown) in the investor's profile database 72, as pre-determined by the broker. This function saves the broker and investor time because when the desired rate becomes available, that rate is automatically locked or a notification is sent to the broker to make a decision on whether to lock the rate or not. The broker no longer needs to view investor rate sheets manually on a daily basis looking for a requested price on a date.

Often critical lock opportunities are lost because the interest rates can change daily or even hourly. This can cost brokers, investors and borrowers thousands of dollars and can be avoided by auto locking loans. Occasionally, when a broker misses a lock, the rate will not become available again. The borrower will often cancel his loan and search for a new broker to arrange the loan. This function saves all of the parties involved money and frustration, as well as saving the broker and investor time and reducing human error. This takes pressure off brokers from having to watch multiple rate sheets daily looking for requested rates for multiple borrowers. This function also creates more business by not loosing any rate lock opportunities.

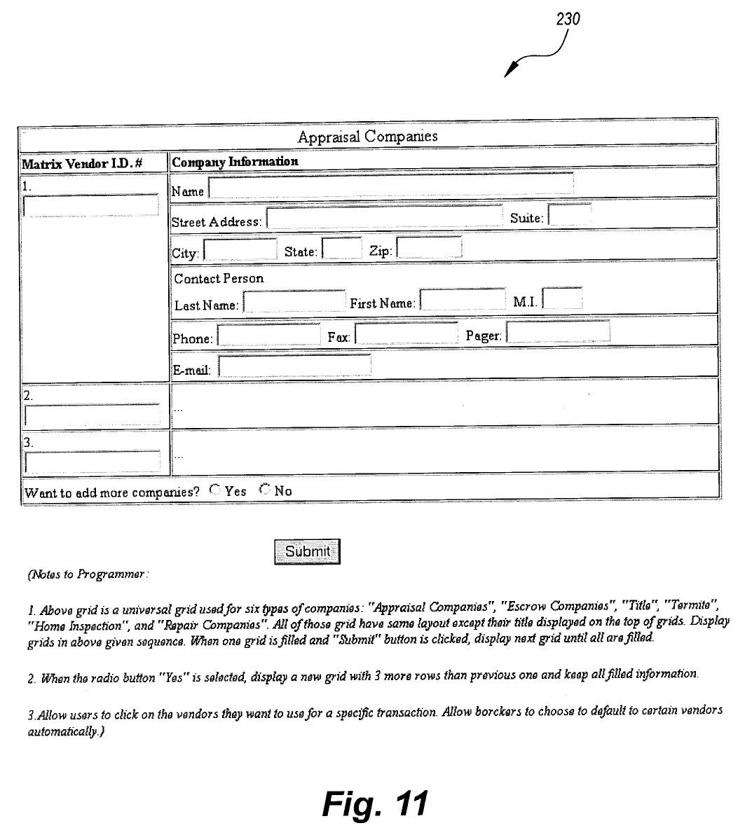

The computerized system 10 also utilizes a broker's favorite vendor list module 230, which allows the broker to store all of his favorite vendors' information and select or pre-select them for his transactions, as he opens them or when he opens them. The broker's favorite vendor list module is depicted in FIG. 11. The computerized system 10 then notifies the vendors that they have a new order and gives them access to the particular borrower file. They can gather all of the data they need here to do their jobs. This is especially important to the brokers in saving time. Currently, brokers must call or fax vendors about a transaction and give the same data over and over redundantly wasting brokers' time. This results in both the broker and the vendor saving time and expedites data flow and closing times.

As is shown with the questionaire module database 74, there are borrowers' files 280, which allow the broker to access his current borrower database (which is part of the questionaire module database 74), including past and present borrowers' lists. This feature allows a broker to find very old or new borrowers through the computerized system 10 and saves time searching for phone numbers and other borrower data. There is also a loan document and funding interface module 240, which allows the broker to order loan documents through the Web site. There is also a communication interface 250 that allows the broker to communicate via the Web site to any investor, vendor or other broker active on the Web site, saving time in communications due to phone tag.

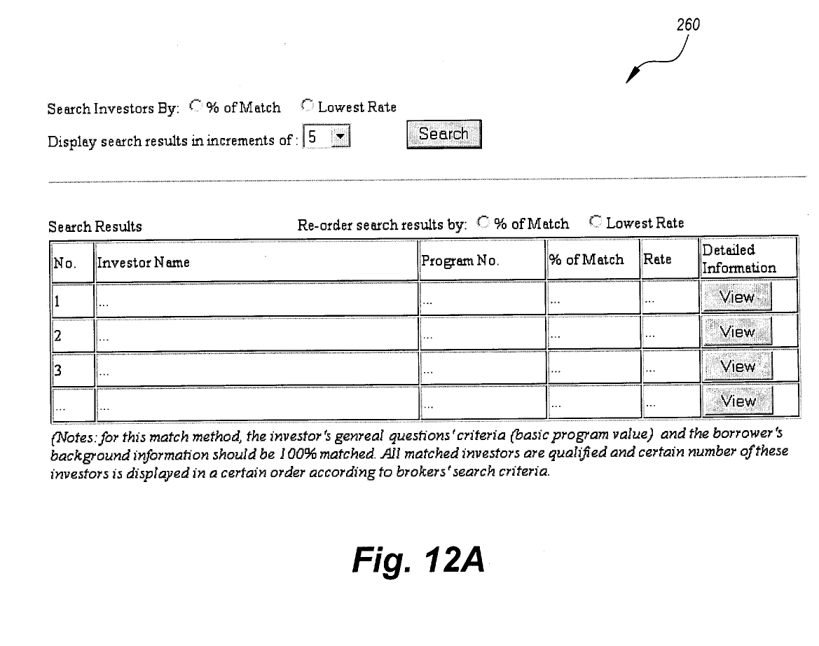

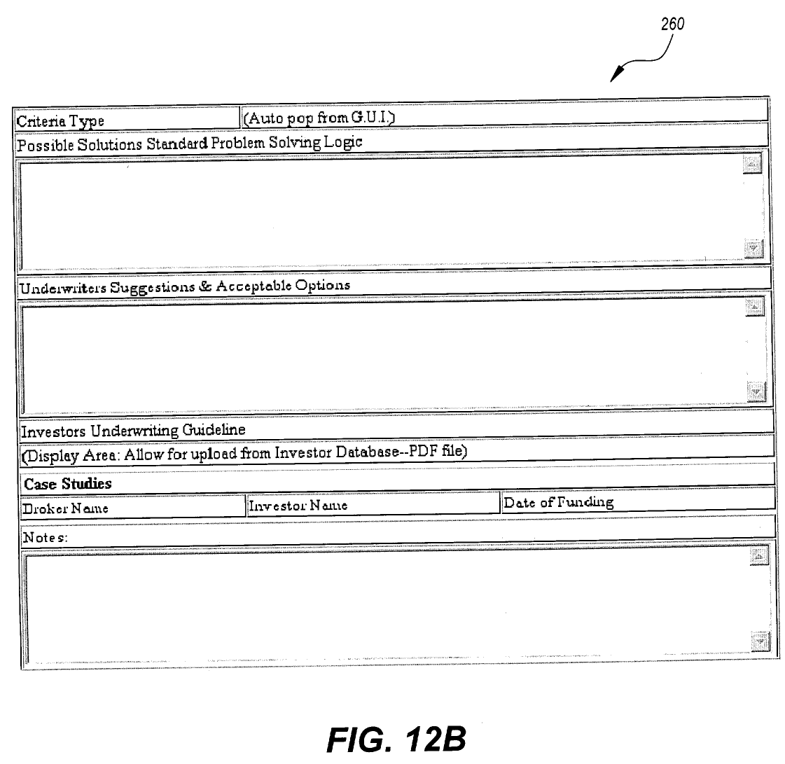

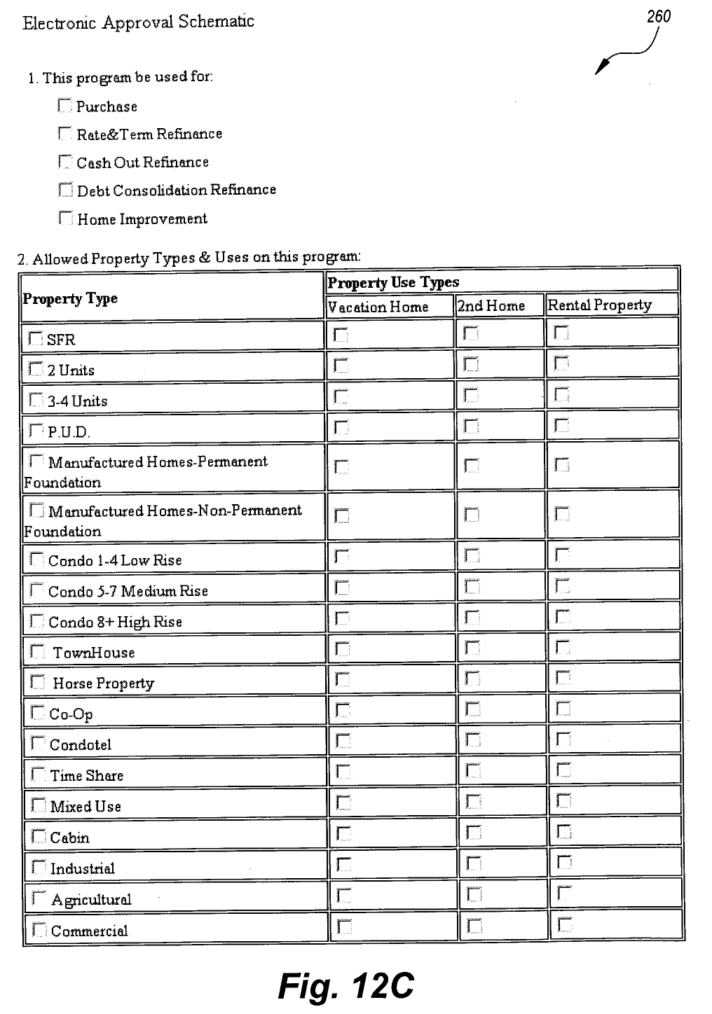

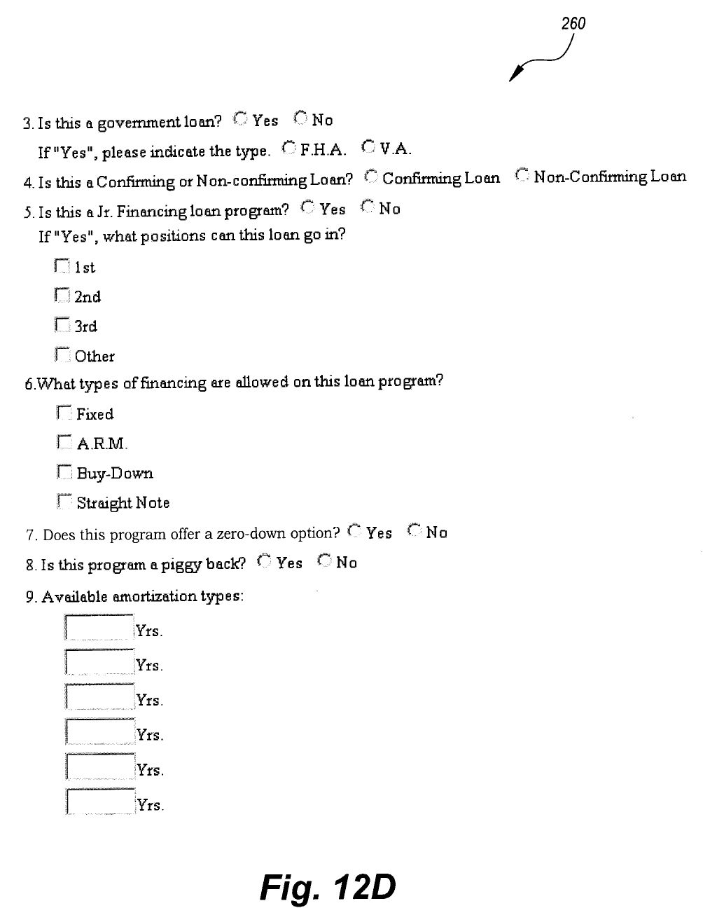

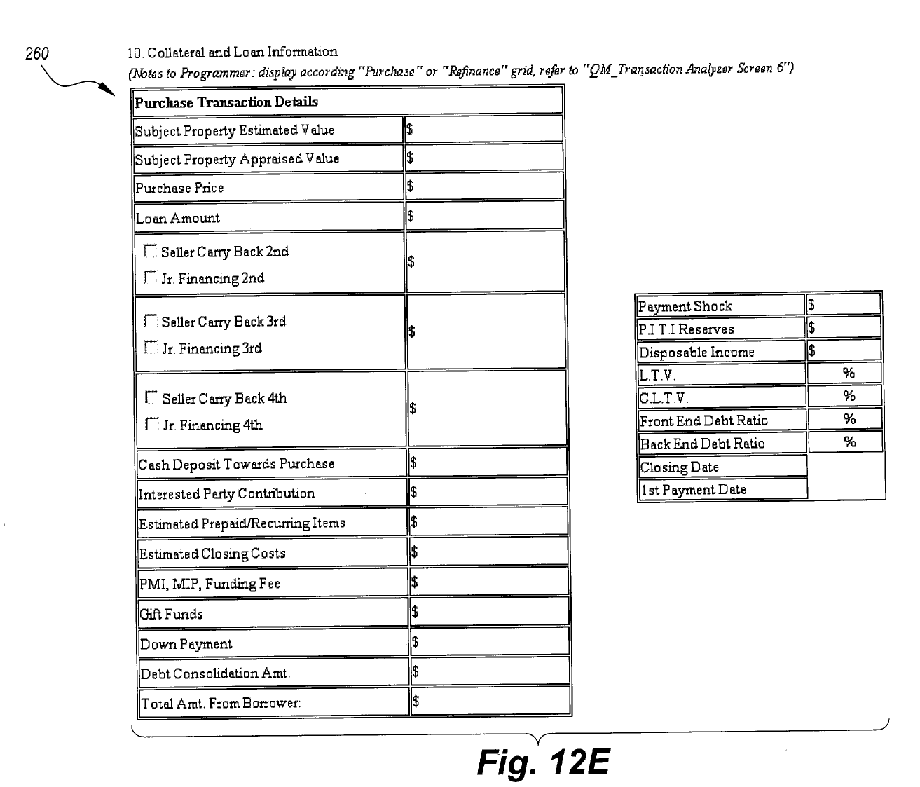

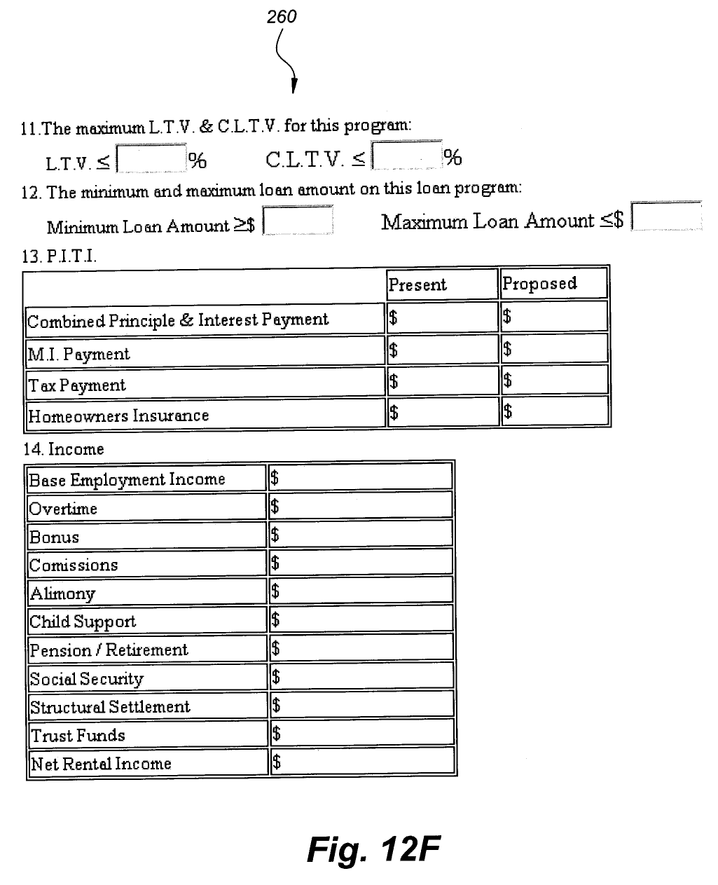

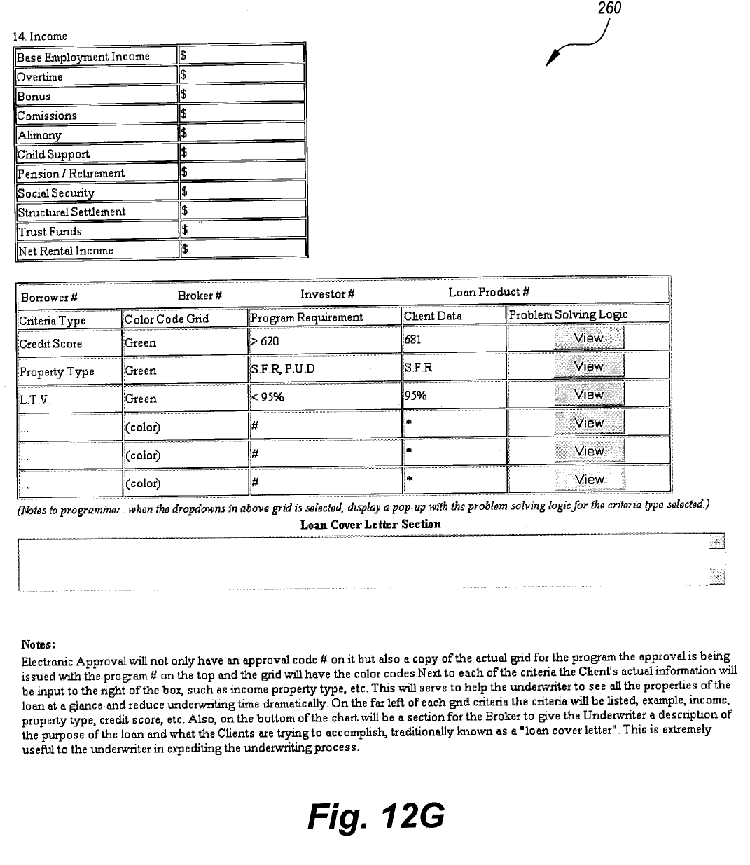

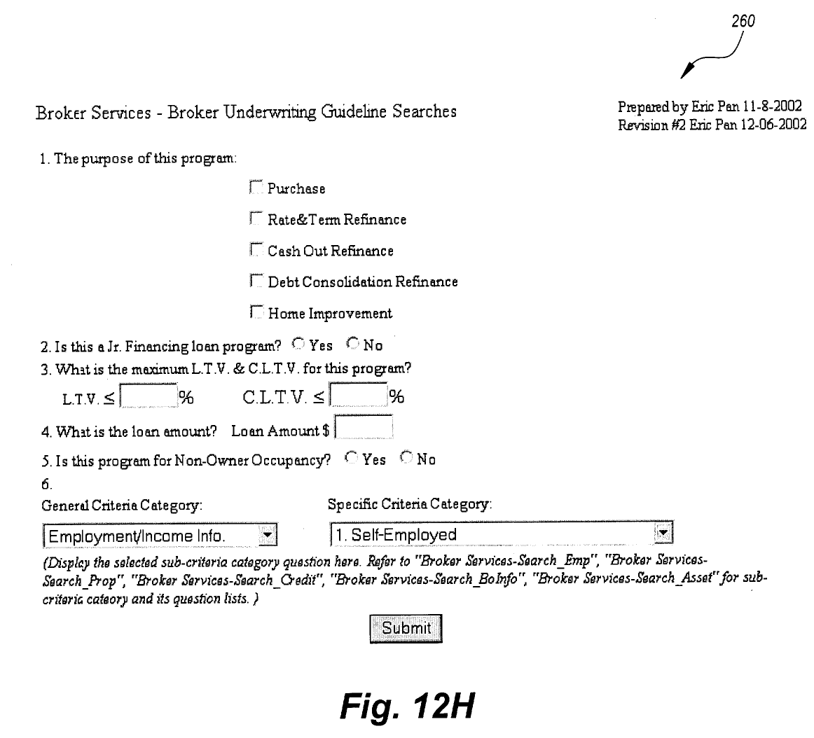

As is shown in FIGS. 12A-12H, one of the major features of the computerized system 10 is the borrower profile electronic submission interface 260. This function allows a broker to search the investors' profile database 72 for a compatible investor for a borrower profile and locate potential matches. Then, using a GUI screen, the broker can choose potential matching programs to be displayed. There is an option for the highest percent of borrower profile match to investor criteria and an option to search for the lowest available interest rate for the program being searched for. Once the search process is completed, the broker and borrower can begin viewing different investors' loan programs and problem solve any non-matching criteria. The criteria is displayed in a color coded format previously discussed in this section.

Once an investor program is chosen, the broker and borrower can submit the loan application electronically using the electronic submission GUI. The underwriter can review the loan application through the Web site and make a credit decision automatically. This module allows a broker and borrower to search unlimited investors in the investor profile database 72 to find the best possible rates or criteria automatically. This can also save the broker time from searching for programs through phone calls to investors and overall expedites loan approvals. There is also a public record interface 270, which allows the broker to check title records automatically through the Web site interface to title company databases and borrowers' public records without the need to call the title company to do a search.

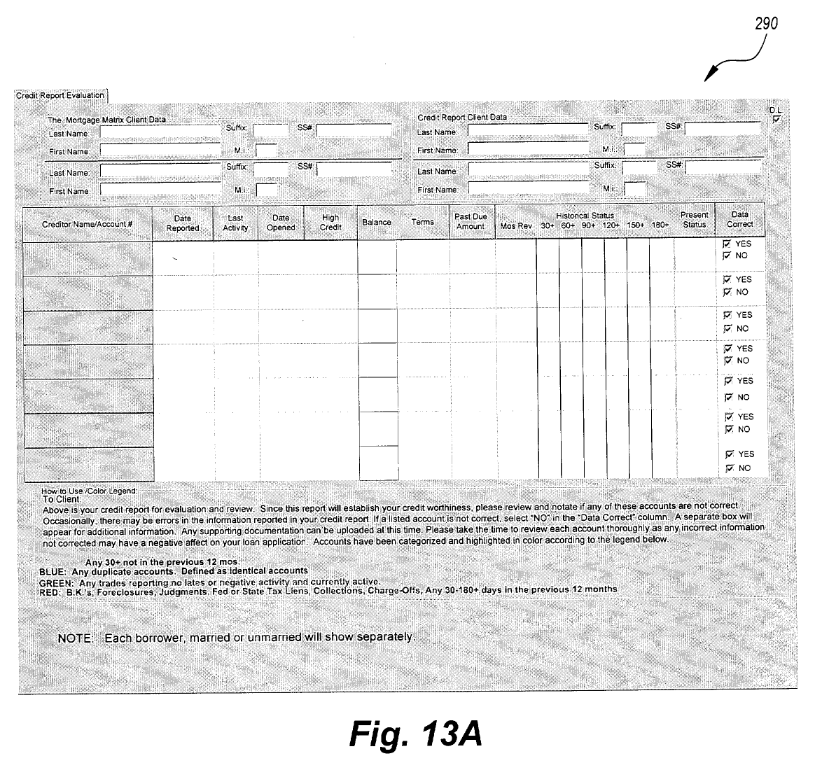

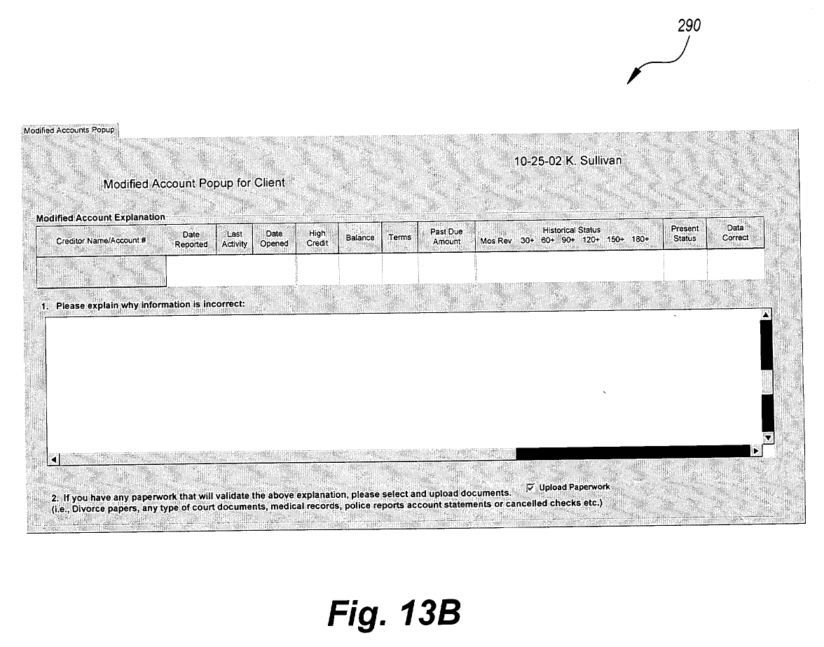

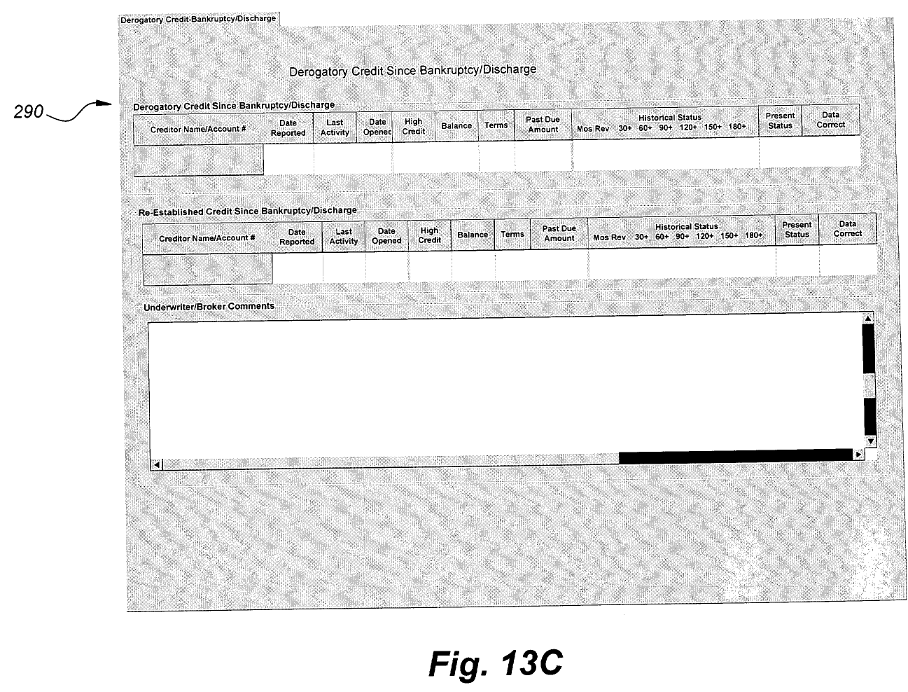

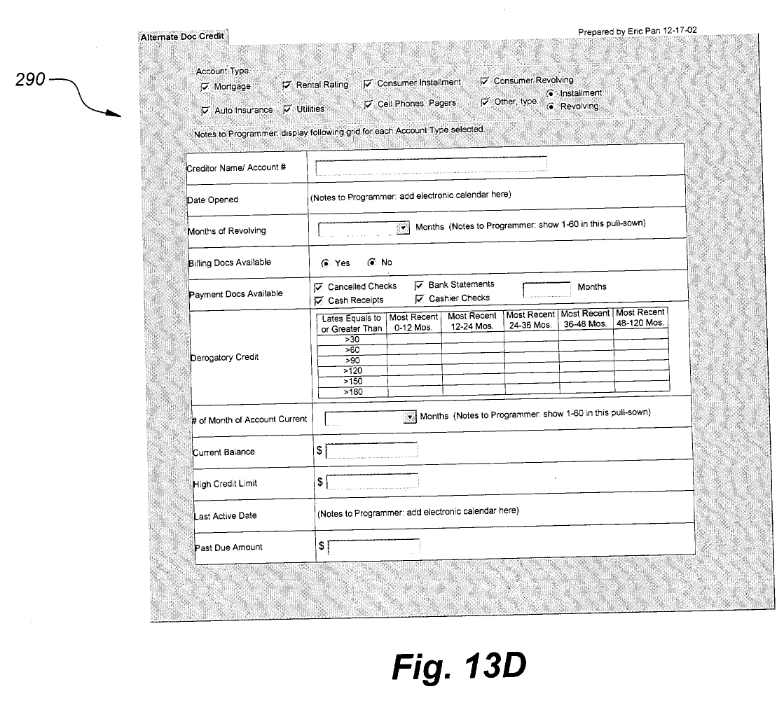

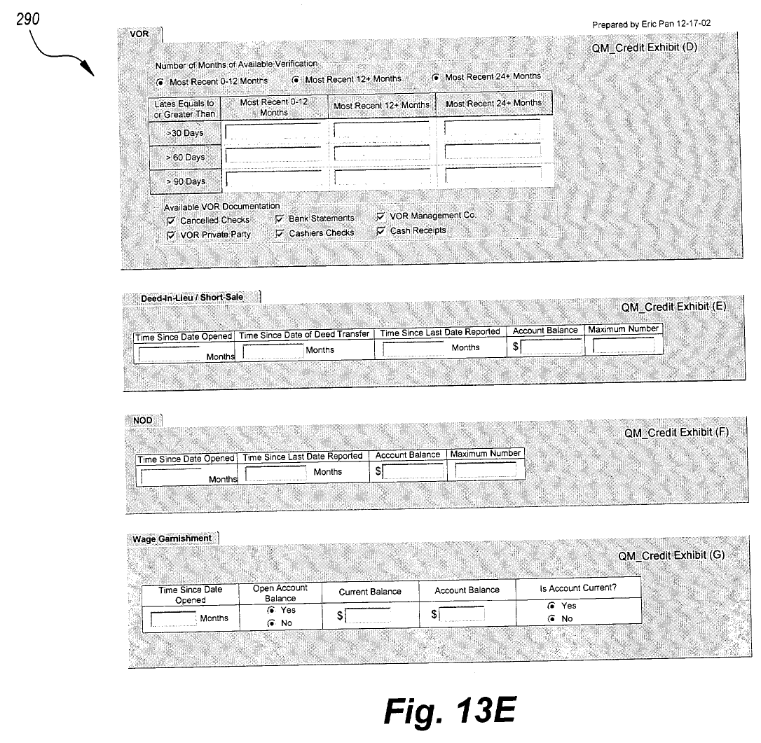

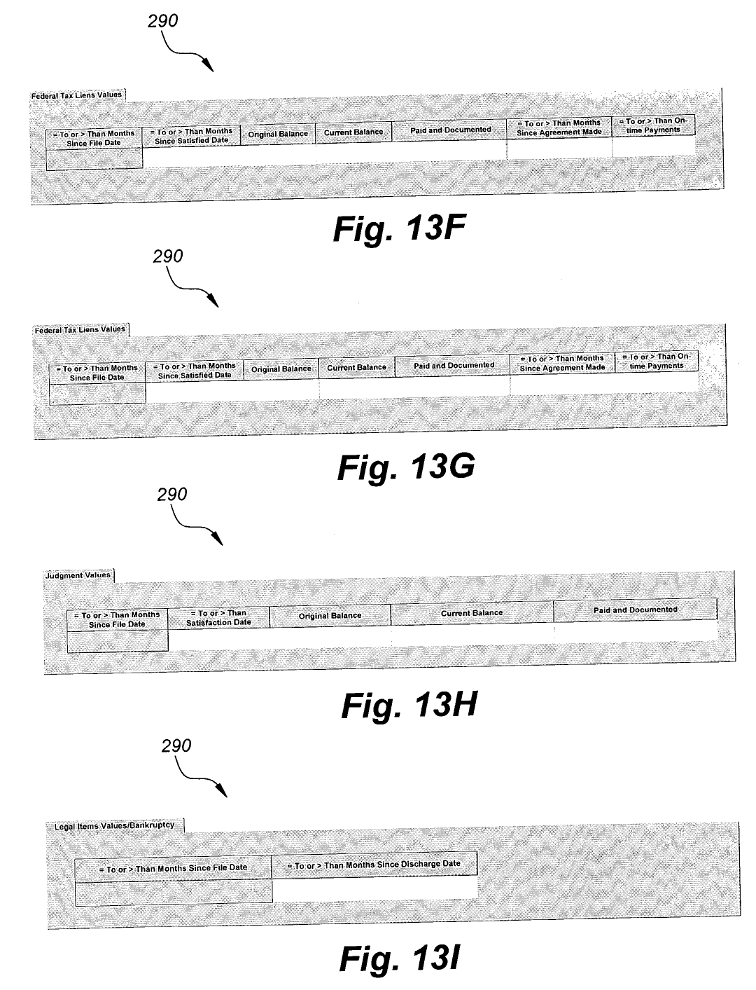

FIGS. 13A-13I depict the credit functions module 290 of the computerized system 10. This module allows the broker and borrower to do overrides on a credit report manually. The purpose of this function is to make quick corrections to credit reports because quite often the credit bureaus make mistakes in reporting. Many times borrowers have solid proof that the items are being reported are in error. Therefore, the broker and borrower can override the credit report and upload documents to prove the item is incorrect. This way a borrower can submit a loan application without incorrect items being counted against them. This module is programmed to ignore that data marked incorrect when it begins the matching process to the investor program criteria. When a match is made, the underwriter can view the disputed item and decide to accept or reject the explanation and documentation given. This credit override allows borrowers to side-step the credit bureaus and move on with their lives without the need to wait for credit bureau review.

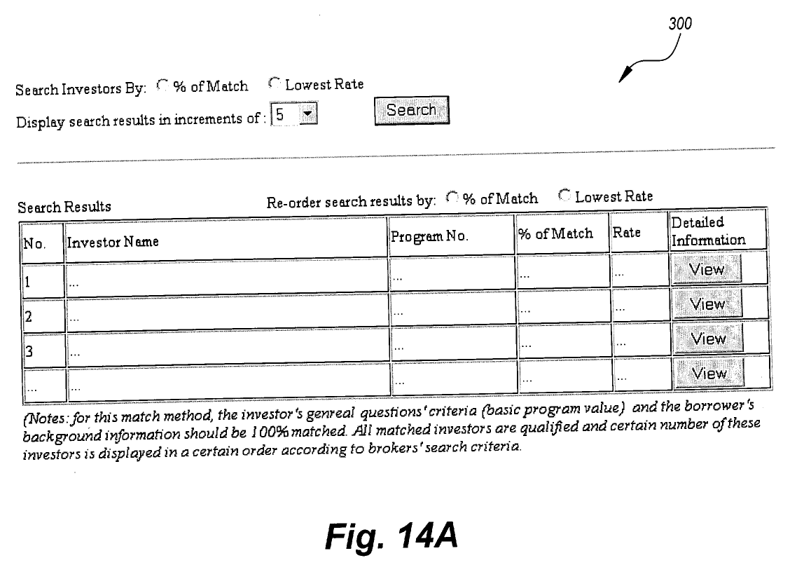

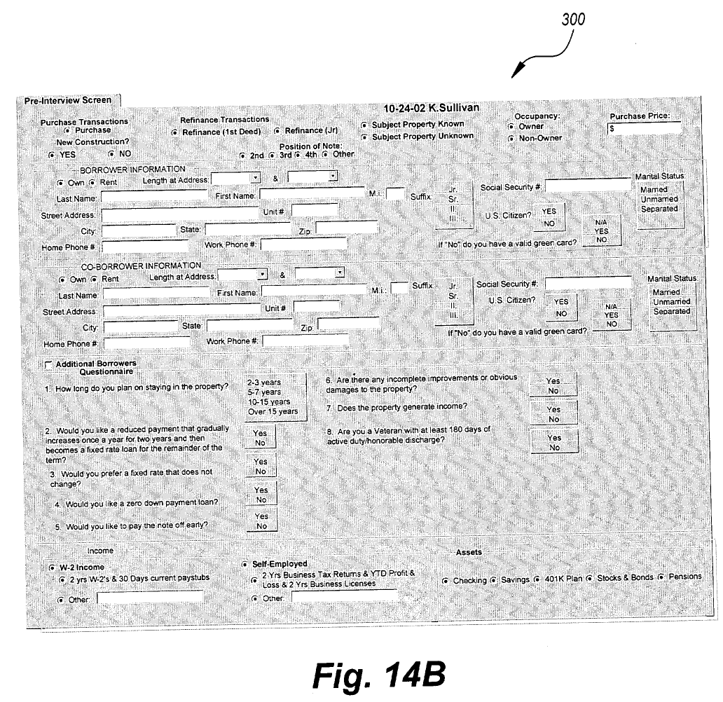

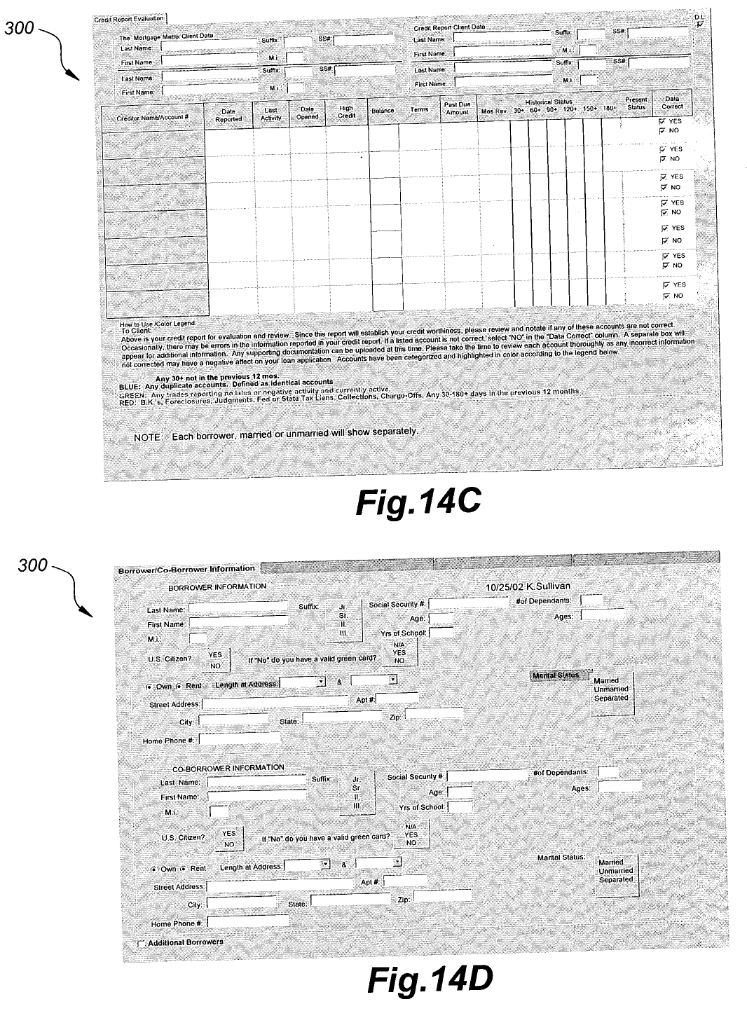

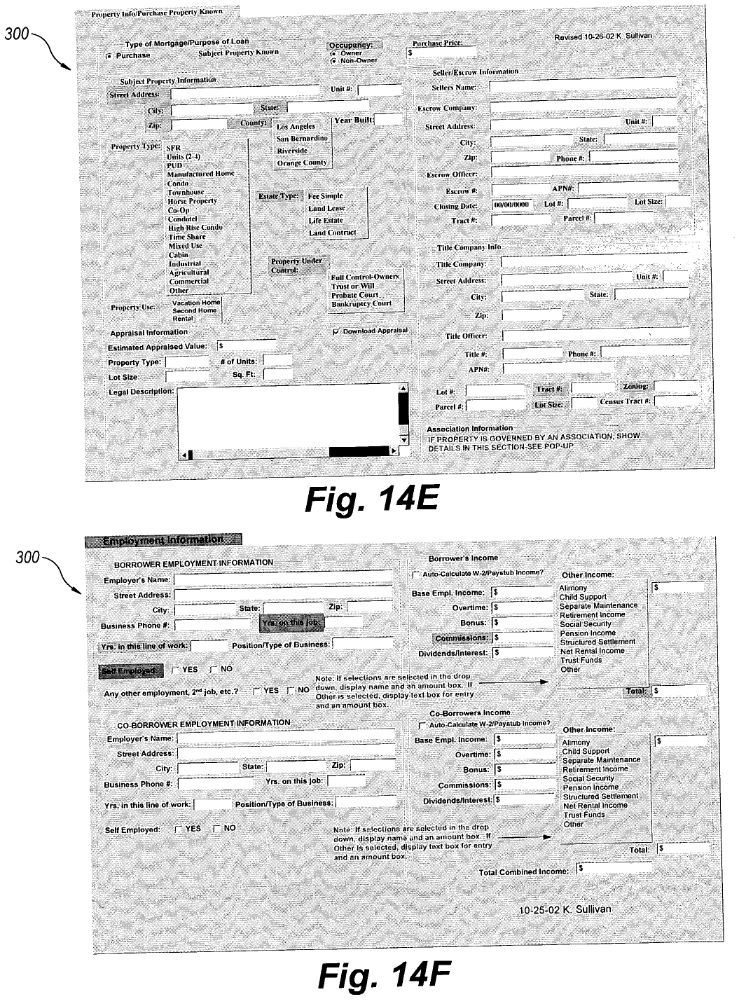

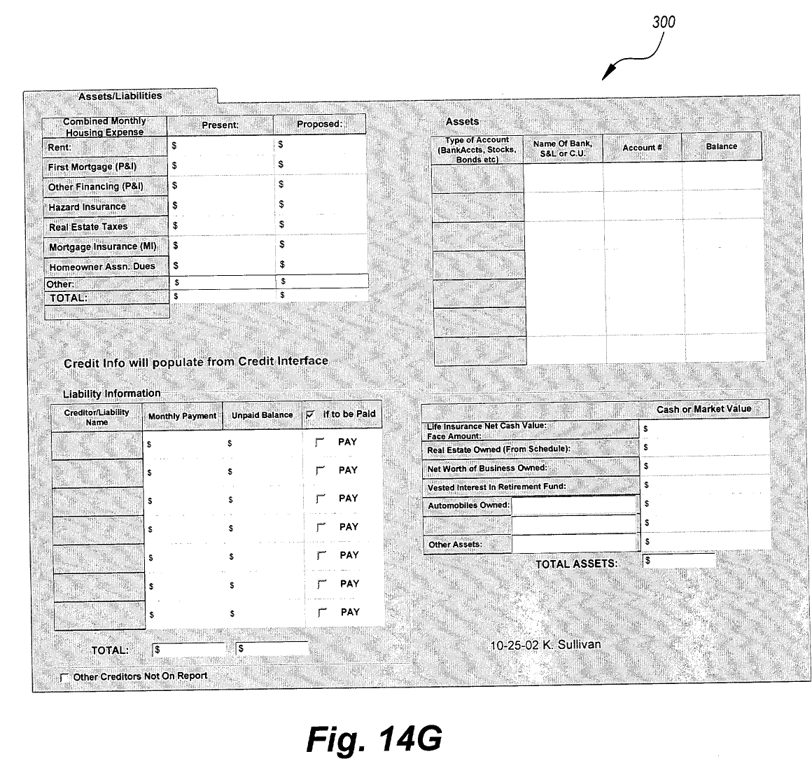

FIGS. 14A-14G depict a smart loan application 300 and flowchart, for all of the borrowers' data in one place. The smart loan application 300 has training benefits for a brokers' new and unseasoned hires. The smart loan application 300 has pertinent questions built into each sub-module. For example, the employment sub-module will prompt a new hire to ask questions that will qualify the borrower for the best possible rate and guideline financing first by asking if the borrower can supply 2 years worth of the highest level income documentation W-2s and thirty days current pay-stubs (for a wage earner type borrower). If the borrower cannot supply this documentation, the smart loan application 300 prompts the new hire through a group of questions to find the best possible documentation that this borrower has.

The benefit of the smart loan application 300 is the new hire finds the best possible financing for the borrower without making mistakes or having to stop his application process to ask the managing broker what to do. The managing broker benefits from this module by being able to hire non-seasoned new hires that can immediately and effectively start writing business without the need for extensive and costly training. Eventually, the new hires learn from the computerized system 10 by identifying patterns and memorizing processes after gaining experience with the computerized system 10. All of this is accomplished while new hires are earning money, and the brokers are profitable as well. The smart loan application 300 collects all of the data necessary to complete a full loan application, while training new loan officers and brokers, while writing business and remaining profitable. This also reduces human error in new loan officers and brokers placing borrowers in loans that may not be the best programs for them.

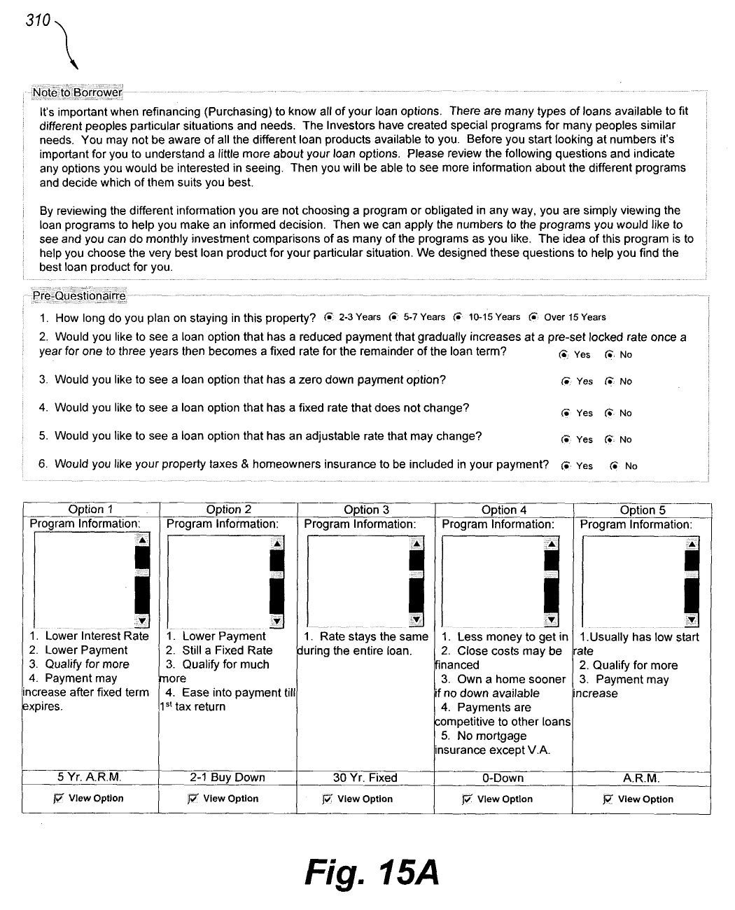

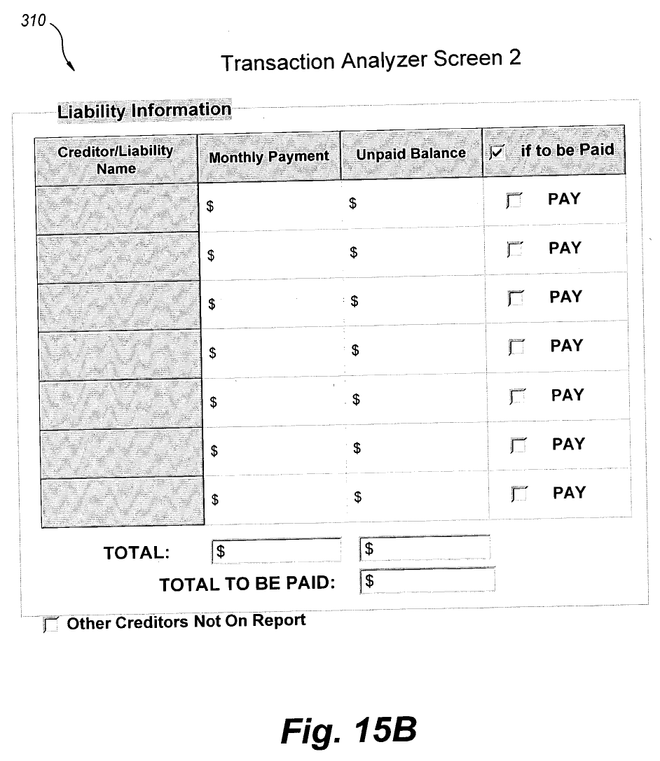

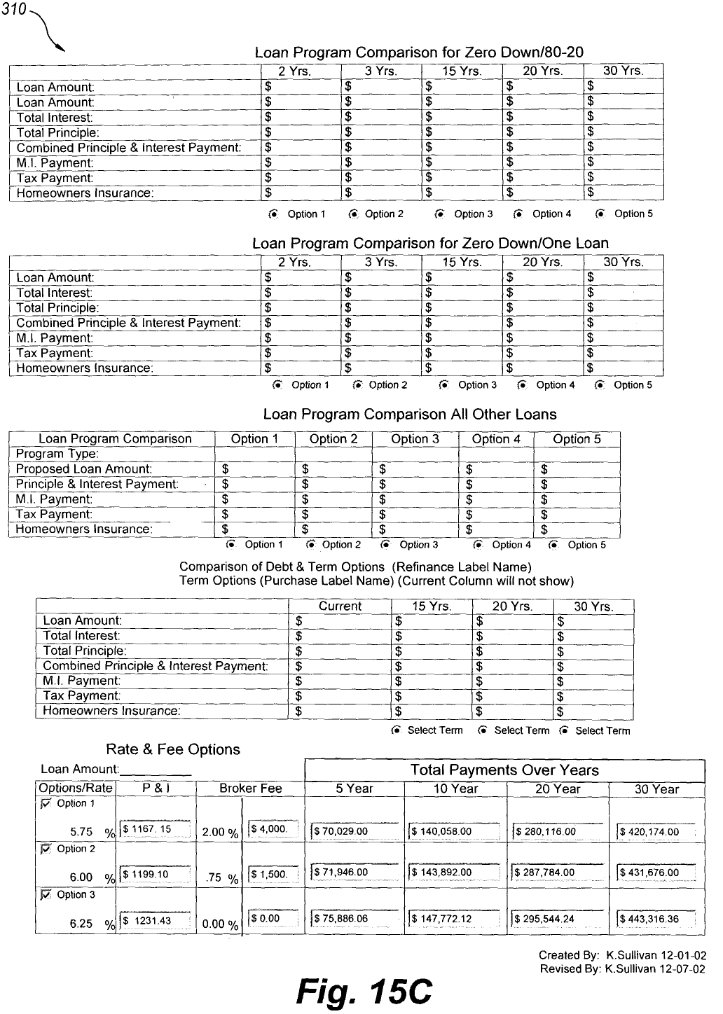

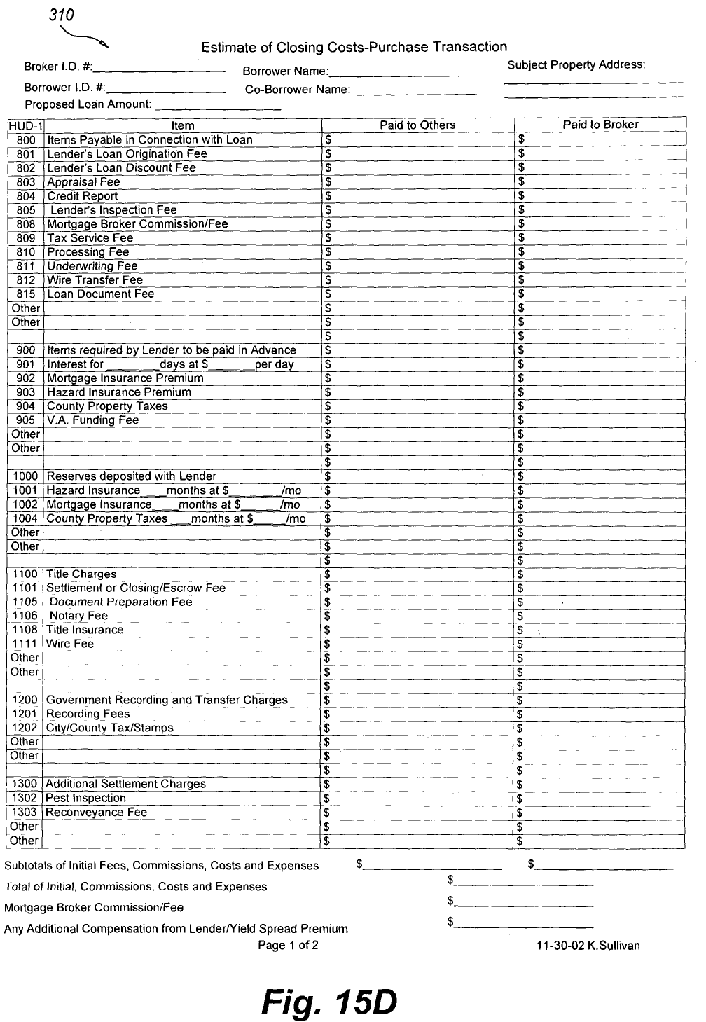

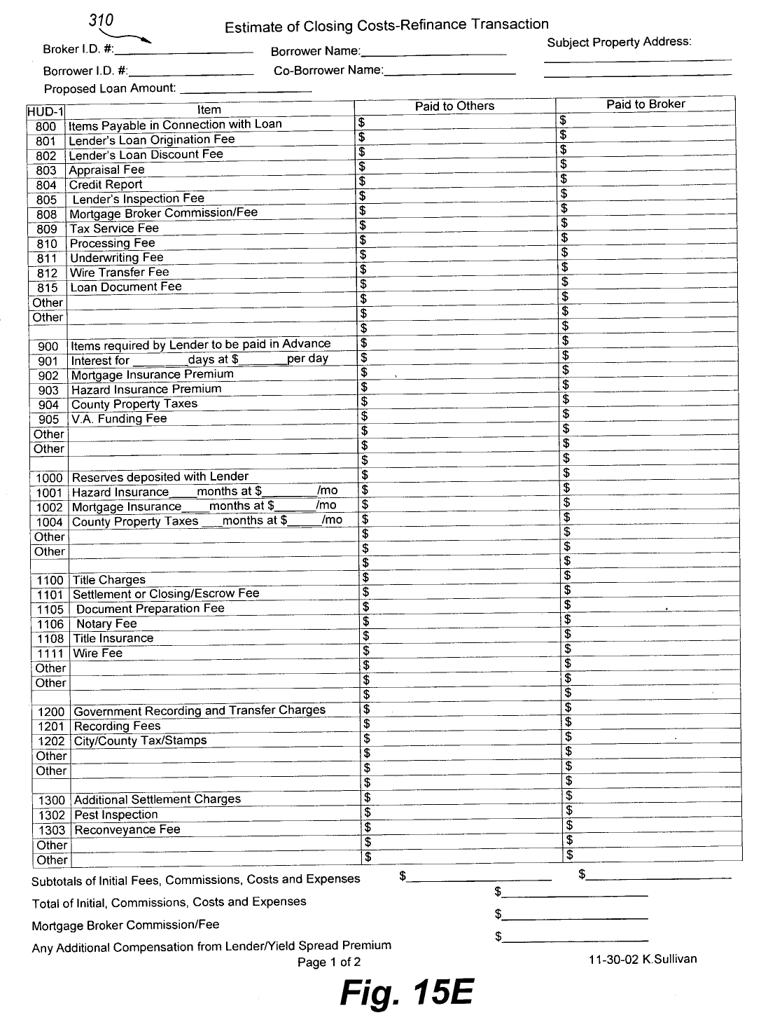

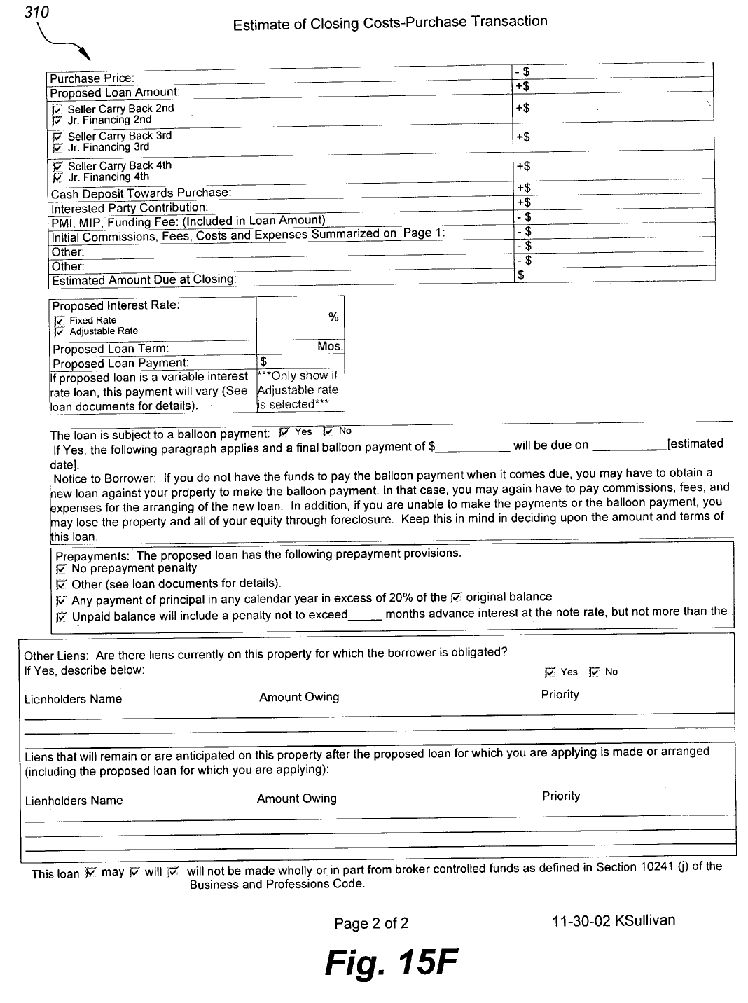

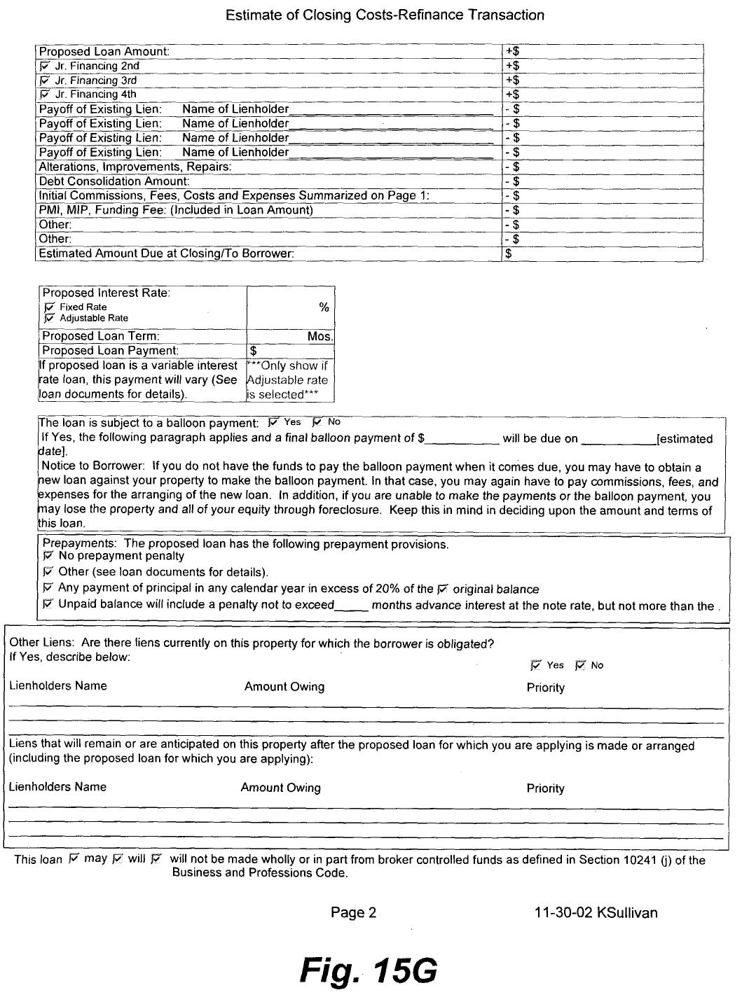

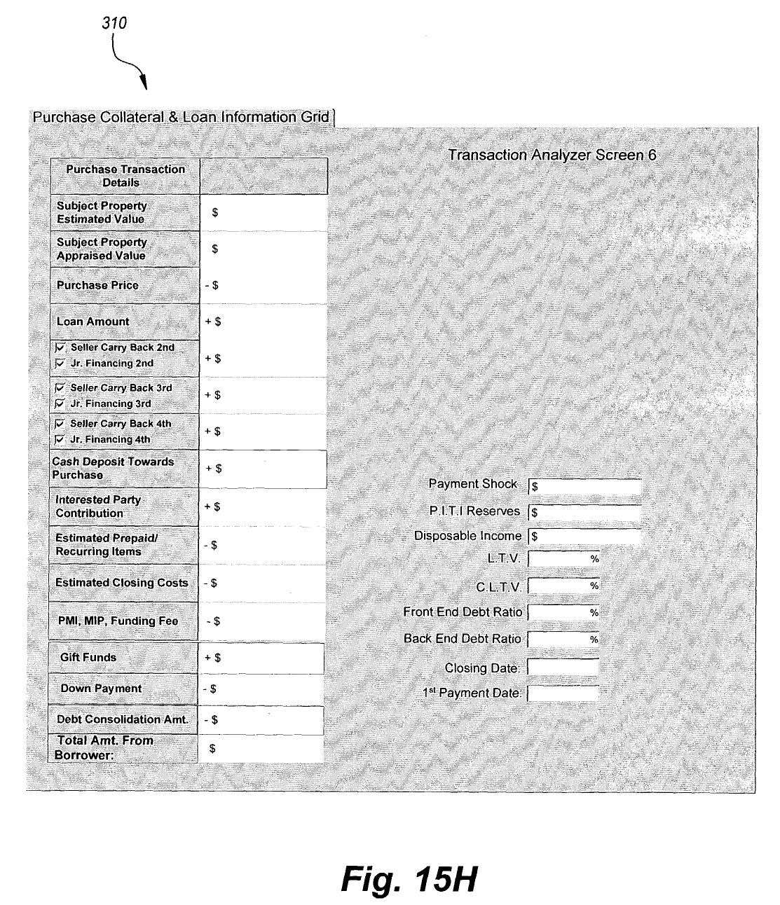

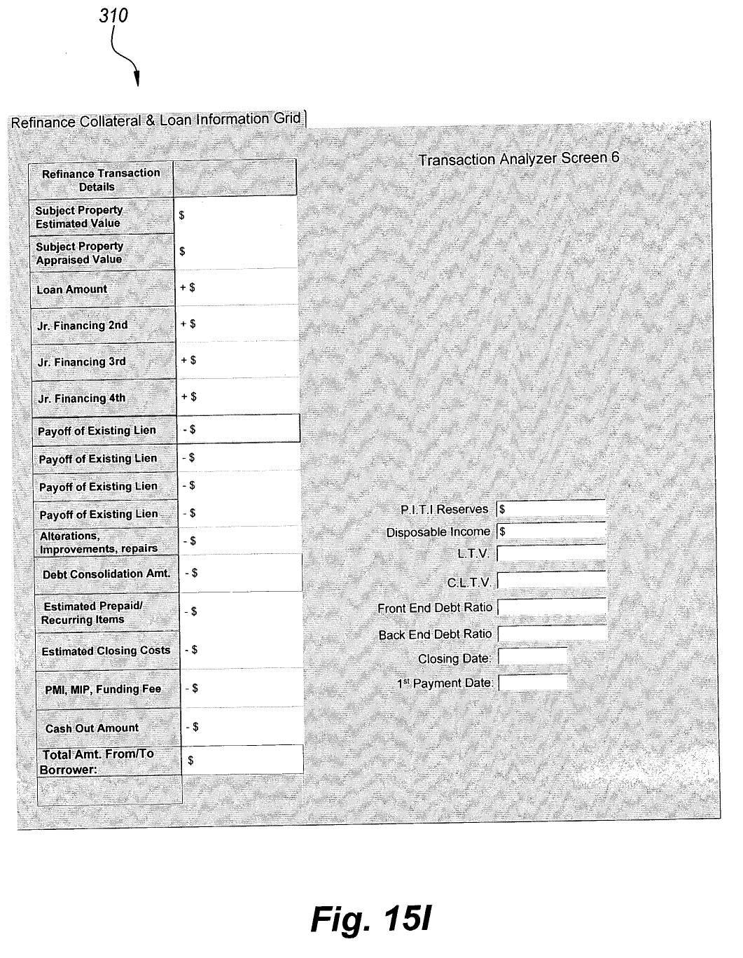

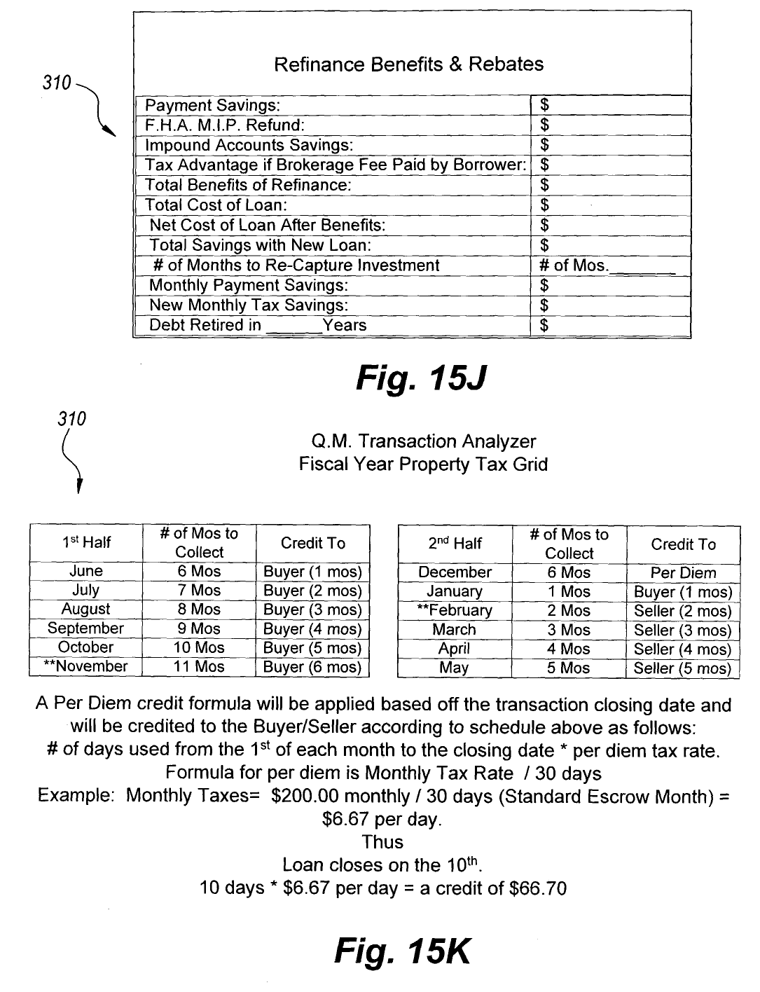

FIGS. 15A-15K depict the transaction analyzer module 310 of the computerized system 10. The transaction analyzer 310 populates data from the smart loan application 300 and calculates and uses investor program formulas for the broker. The transaction analyzer module 310 also shows borrower options, shows fee schedules pre-loaded for the broker, allowing broker to preset the minimum fee his office must charge on a loan and also calculates the maximum fees per local and federal government regulations that may be charged and notifies the broker if the amount has been exceeded by delivering a warning message. The transaction analyzer 310 displays remaining interest on all debts and compares it to options and shows total interest saving over the term of the loan. Smart questions are asked to help brokers and borrowers look for the best loan options for the borrowers' situation and educates both on the features of those loan programs. Potential savings on different terms are shown once a loan program is chosen. All of the costs of the loans and the total of all rebates and benefits of the proposed loan are displayed. This is then totaled in a net cost, showing total time required to recapture investment, with all of the final pertinent figures in a summary page. The transaction analyzer 310 saves the broker time in calculating any necessary multiple formulas, while educating the borrower on loan programs and interest saving tips. The transaction analyzer 310 automatically default's pricing, protecting the broker from selling a loan for a fee off of the fee schedule and calculates three loan options. The transaction analyzer 310 also shows the borrower the true net cost after benefits and true recapture time instantly, to assist an educated decision on a loan program and offer.

The computerized system 10 also uses a transaction coordinator 170, which uses preprogrammed algorithms to display all brokers, investors, vendors and borrowers to the loan transaction the target close date and all target dates to complete their obligations to close on time while simultaneously excluding weekends, county recorders' closed days and holidays from the available working days to close. The transaction coordinator 170 also allows all parties to view the transaction through the transaction coordinator 170 at any given time day or night and to make updates or to simply view current activity. Also the transaction coordinator 170 can upload or download documents needed, to close and communicate with any and all parties involved. A time and date stamp on every entry is recorded. This module is color coded and divides the transaction into phases for tracking the color codes, as well as showing the progress of the transaction completed items to close and also indicate if the item due is completed or past due. All parties to the transaction can view and or update status on the transaction coordinator 170 anytime day or night. This saves wasted time from phone tag and the sharing of data. The data can also be downloaded by the parties to the transaction and loaded to their own computers.

The computerized system 10 uses credit valuation logic (not shown) to read the credit report of a borrower through an automated system and color codes credit items for a new or seasoned broker to quickly read, then during program matching, matches the values of the borrower's credit to the investor's credit requirements. This logic is programmed to read specific data on a credit report such as the date and when the account was opened, the number of on-time payments made on the account, the current balance, the high credit limit, any past due amounts, the number of months the account has revolved and whether it is an installment or revolving account. The logic has capabilities to read any item on the credit report just as a seasoned broker or loan officer would, without any human error. Once the program reads all of the credit lines, it valuates them and color code's them for quick viewing by the broker and borrower.

The logic can also handle non-traditional credit accounts and allows them to be included in a borrower credit file (Nontraditional credit items are credit accounts such as rent and utilities.). The logic also allows manual overrides of incorrect data to assist a borrower to locate the correct financing program during the matching phase of the approval process. The logic can also read and display credit items after a bankruptcy (good or bad). Most investors are concerned in particular with these types of items. The logic trains new brokers' loan officers and familiarizes them with credit reports. The logic expedites and simplifies the reading of credit reports for borrowers and prompts the broker on which credit items to pay special attention to, as well as eliminating human error. The logic also pulls specific data apart and displays it in easy to read groups, while allowing manual overrides of incorrect items and easy uploads.

There is also an interface to outside databases that allows the computerized system 10 to collect data on borrowers from human resources department intranet servers, the Internal Revenue Service, banking institutions, the Veterans Administration, the Department of Housing and Urban Development, condo certification companies, title companies, public record companies and outside employment verification companies. These parties are used to gather borrower information the broker may need to populate data into the smart loan application 300. It is possible with these interfaces that borrowers may need little to no paper documents to apply for loans. This saves the broker and the borrower time from gathering paper documents and completing redundant paperwork, which expedites the process of applying for a loan and saves the broker money in reduced processing.

The computerized system 10 saves all of the repeat borrower's files and data for review of old terms of notes and other related information and allows the broker to start a loan for a past borrower quickly by populating previous data into a new loan file for a new loan. This function also allows a broker to take over a borrower's file prior to an escrow being opened if the borrower comes to that broker wanting to change brokers for any reason, without the need to reapply and reload the borrower's data into the computerized system 10 (especially the credit information). The borrower can give the broker permission to take over the file and “deauthorize” the old broker from the file. This helps brokers efficiently assist past borrowers and saves broker time and money costs of reprocessing loans using stored data. It also saves borrowers' time and aggravation with a quick loan application process.

A big disadvantage for borrowers shopping for mortgage loans is most any broker or banker will want to pull their own in-house credit reports to give quotes on loans. The disadvantage comes when the potential borrower has multiple inquires on their credit report, because this reduces their credit score. If a borrower's score falls too low due to inquires, they may not be able to qualify for the same program they would have before their credit score dropped. The smart loan application 300 runs one tri-merged credit report (all three credit bureaus in one credit report) per borrower. The investors all agree to share this report to view the borrower's loan profile. The smart loan application 300 pulls the credit report apart and reformats it to any potential investors requirements at the program matching stage of the loan process. Therefore, the borrower can shop and search unlimited investors for financing with only one inquiry on their credit report. Then, when the borrower has found suitable financing and the investor approves the borrower application, that investor may run a back-up credit report for verification and quality control purposes. With this process, the borrower can be certain that they will receive only one inquiry during the entire shopping process. Then they will have only one more inquiry until funding. This assures the borrower using the system that they will not be disqualified due to a large number of credit inquiries and their credit score will be protected.

The computerized system 10 also has a processing program (not shown) to allow a broker to have all required documents completed by having all borrower data auto populated into the required documents. This processing program is set up using all of the common forms for the industry and auto populates the data into the smart loan application 300. Any required documents from the broker or the investor can be uploaded into the smart loan application 300 administration for adding. This saves the broker and investor time and money in processing time and costs and is a free service through the computerized system's Web site.

The computerized system 10 also allows users to use an electronic signature feature to allow a broker to speed-up processing and reduce costs of printing paper copies for borrowers of loan documents. A borrower can also elect to receive a compact disk copy of the entire file at close if desired. This helps in speeding delivery of a loan application to an investor. Using the electronic signatures feature, the borrower's loan application can be immediately uploaded and viewed by the investor immediately. More and more investors are accepting electronic signatures everyday and most investors accept appraisers' electronic signatures to allow them to e-mail directly to the investor underwriter.

PDA links are also gaining popularity and allow brokers, borrowers and all vendors involved in the transaction to download files and closing schedules to a PDA. The PDA is excellent for remote access to necessary file information. Another valuable feature of the computerized system 10 is the use of crystal reports (not shown). The crystal reports can be print for brokers and clients to see what documents or requirements they need to close their loan, reminding brokers and keeping the borrower from forgetting about these documents. This function is used at the pre-interview, program matching, transaction analyzer 310 and transaction coordinator 170 levels.

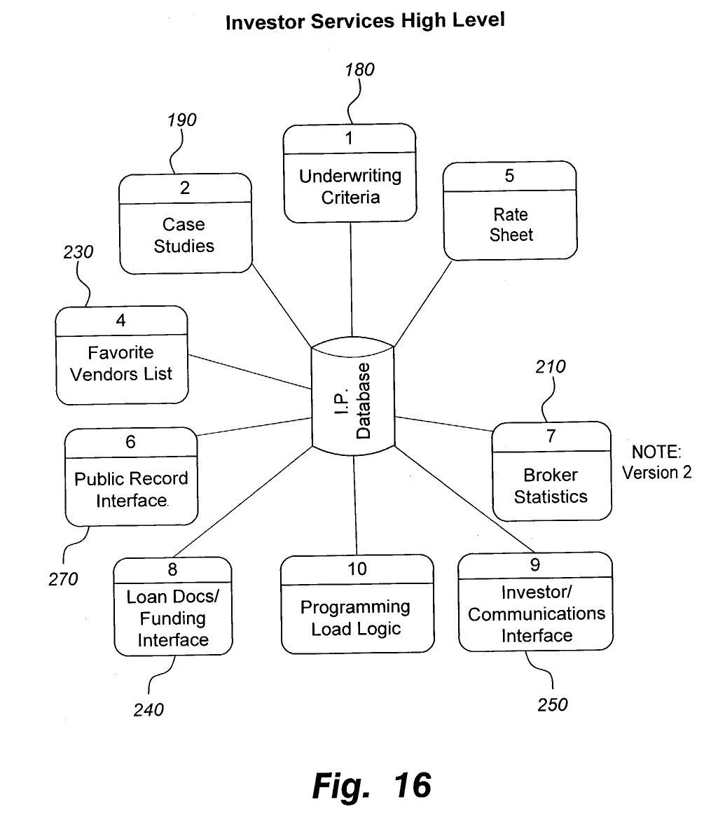

FIG. 16 illustrates an investors' services high-level flow sheet, as opposed to the broker services high-level flow sheet depicted on FIG. 7. The underwriting criteria 180, broker statistic modules 210, communications interface 250, document funding interface 240, public record interface 270, favorite vendors list 230 and case study 190 features are the same for the investor services high-level flow sheet and the broker services high-level flow sheet and have already been discussed and depicted with figures previously in this section.

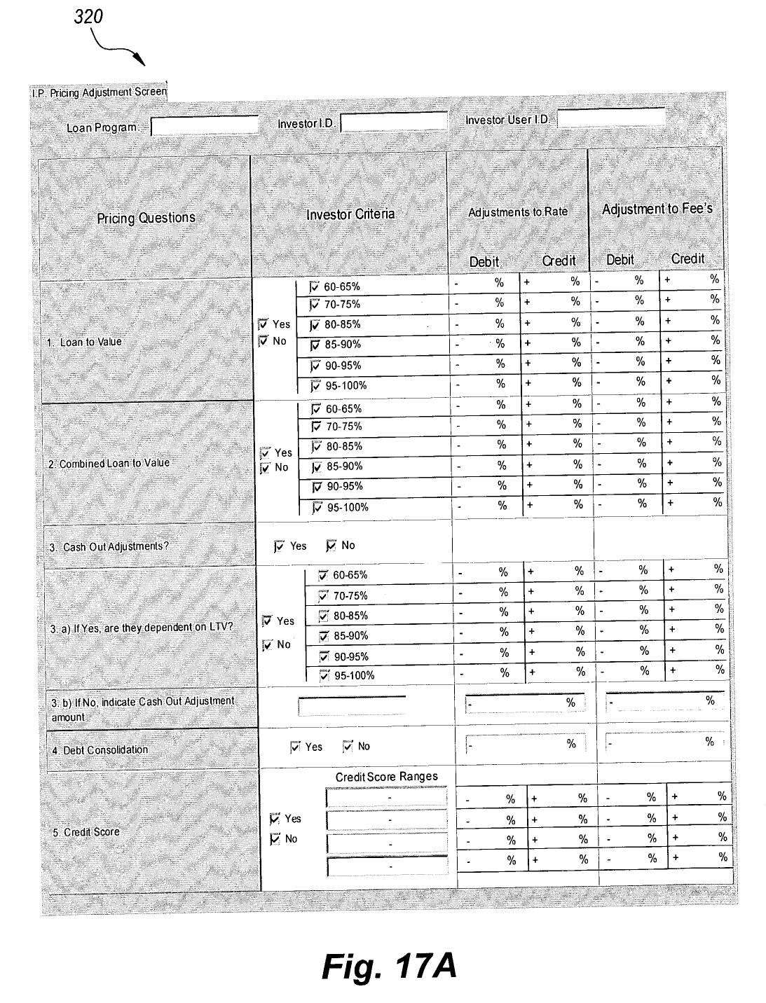

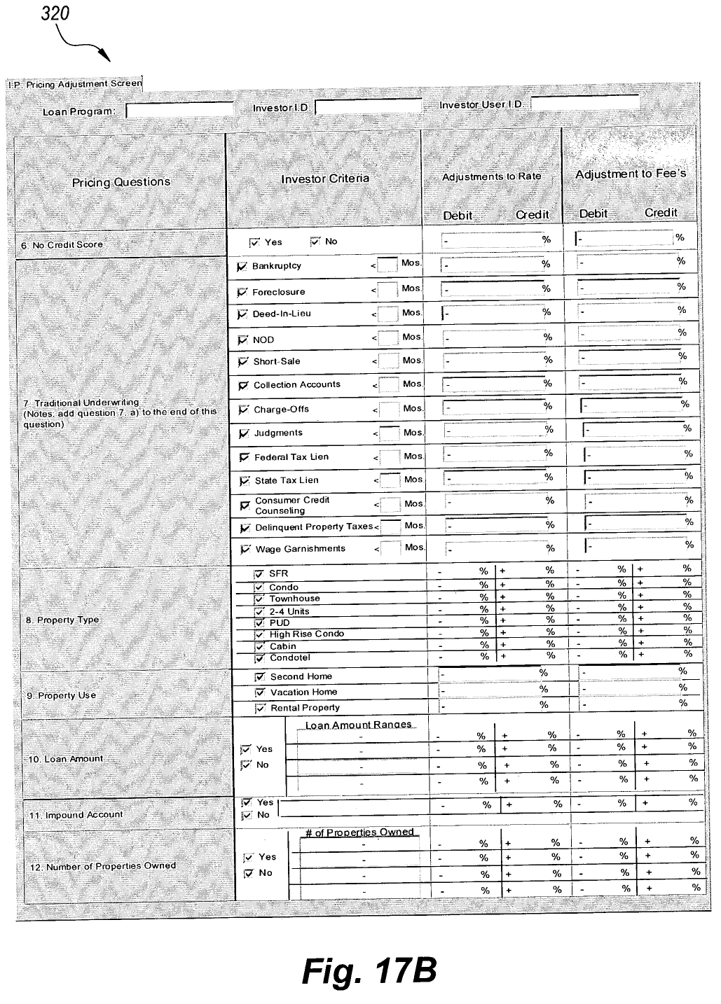

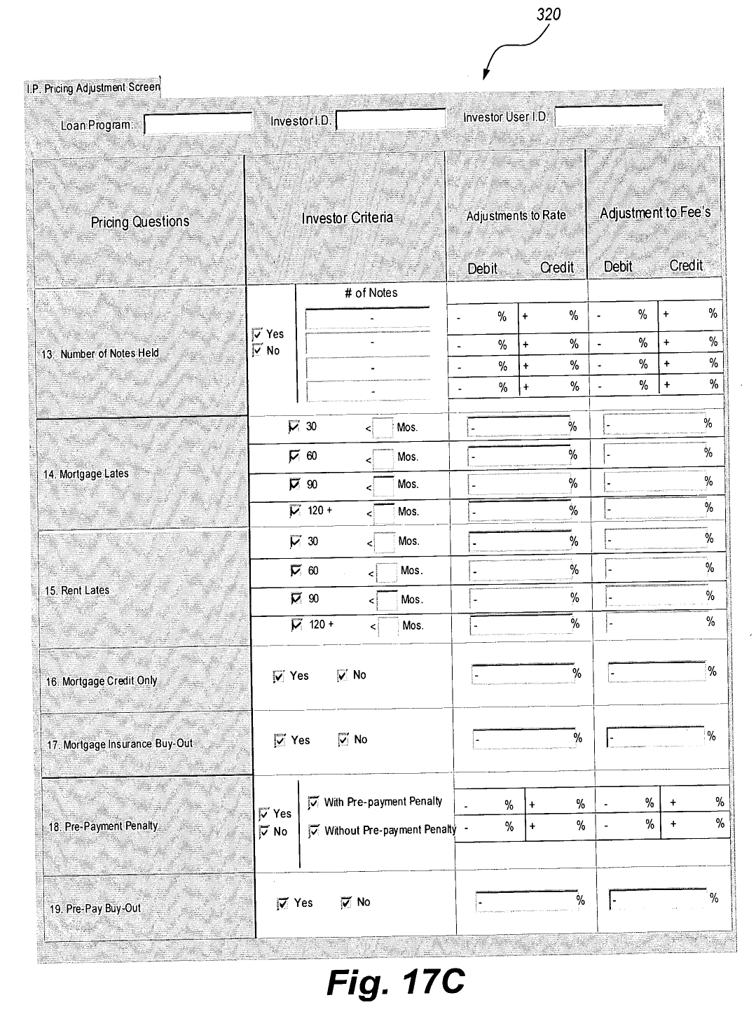

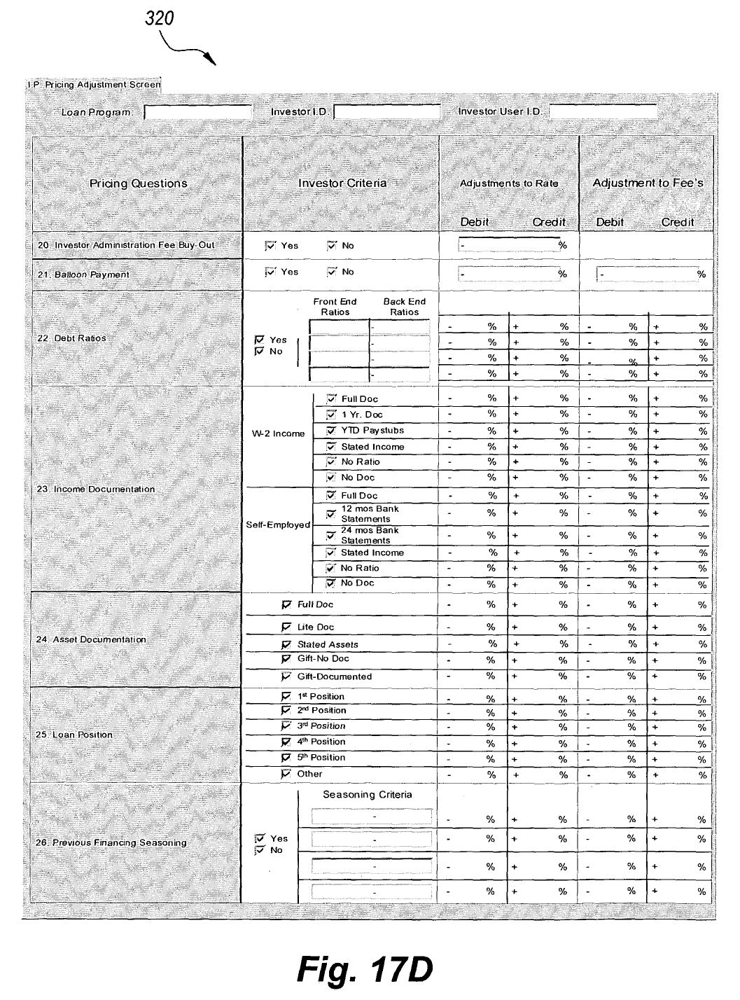

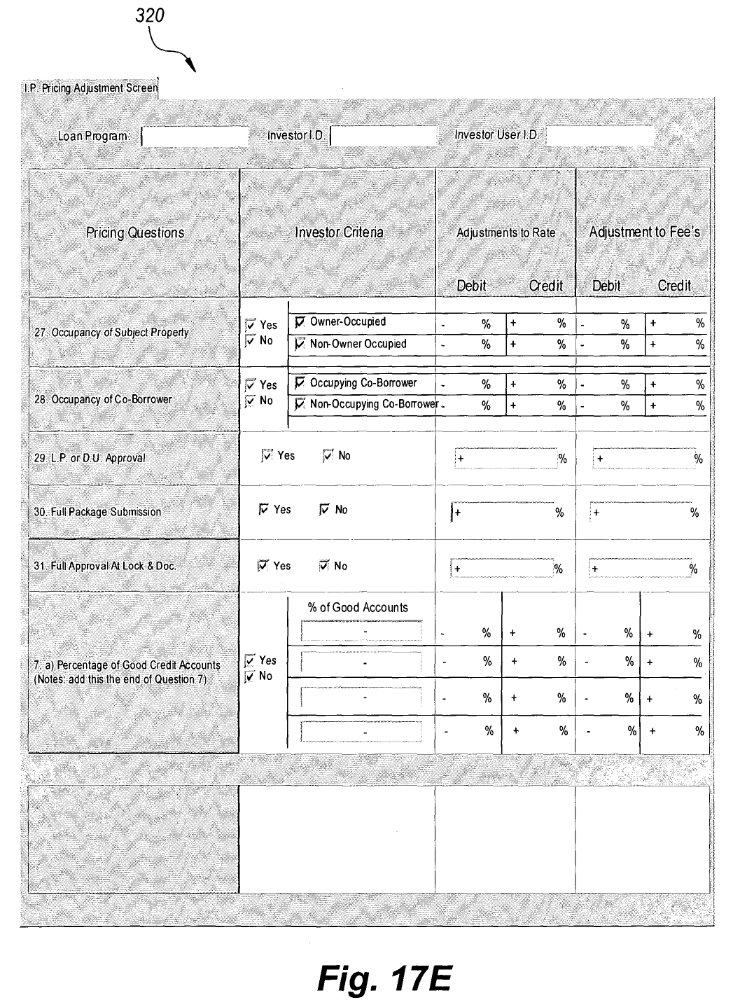

FIGS. 17A-17E outline the rate and fee price loading module 320 of the computerized system 10. This module allows investors to enter their base rates and pricing adjustments to the fee and rate for each program that is offered. They enter this data after they load the base underwriting guidelines for a program. This program interfaces with the borrowers' files 280 to make adjustments to fees and rates on a loan based on both borrower and investor data. Currently most investors tie underwriting guidelines and pricing together. This process is illogical. The computerized system's 10 software completely separates underwriting and loan qualifying from loan pricing.

The price adjustments are traditionally to the fee and rate of the loan and are based on term, program type, loan to value, property type, income documentation and credit. By having the investor pre-load these adjustments, we can automate the process of giving the borrower an instant fee and rate quote at the time of application. Traditionally investors make new rate sheets daily. This module allows them to make them one at a time and then enter a base program rate daily. Then the computerized system 10 can automatically make all the necessary adjustments to the investors' rate sheet by pre-programmed rules. The advantages to this are many and include borrowers receiving instant accurate loan quotes, investors and borrowers automating their processes to save time and money. Human error is also reduced and data is populated to broker and investor forms for easy loan processing. The rate and fee price loading module 320 produces estimates that are more accurate then traditional investor and borrower forms, with large pricing mistakes being reduced.

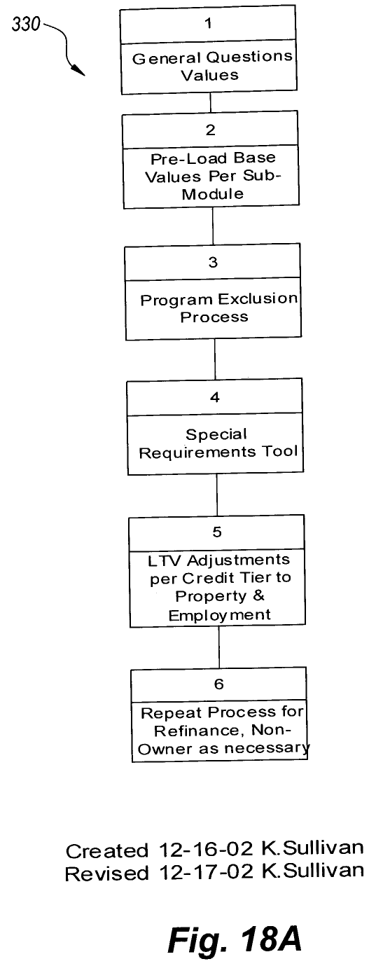

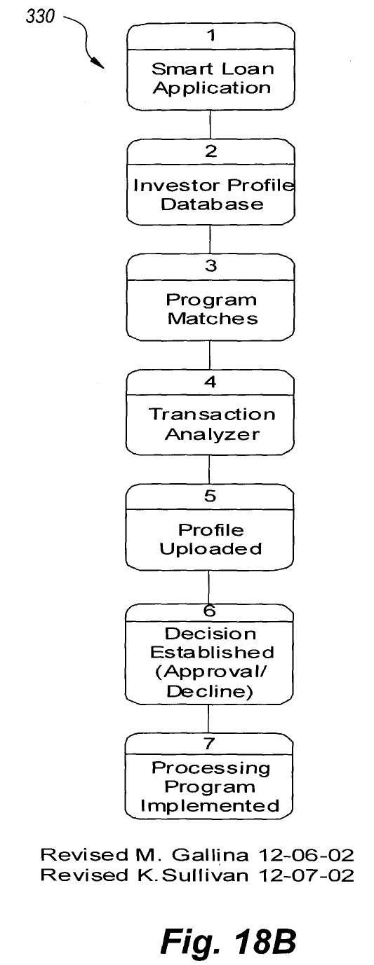

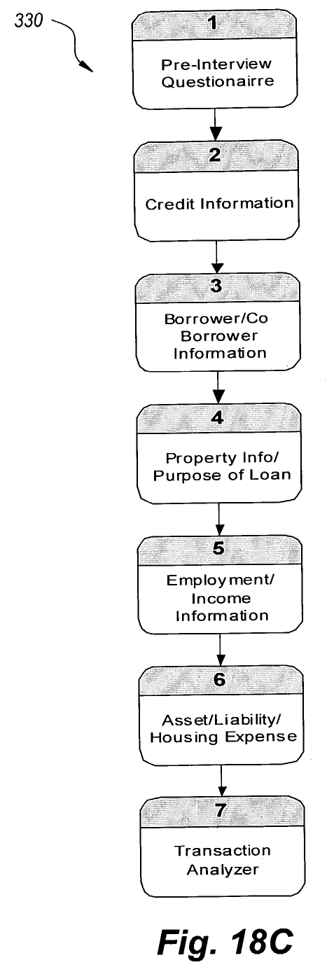

To automate investor underwriting, the computerized system 10 has built-in program loading logic 330 to match borrower profiles to investor loan programs. This is illustrated in FIGS. 18A-18C. This requires the investor to load program data on each loan program offered in the investors' profile database 72. Due to the number of possible variables, the following logic can be applied to load a loan program in the most efficient manner. The time to completely load a loan program is estimated at about one hour using this process. The benefits will come back to the investor many times over with expedited underwriting and pre-electronically underwritten loans delivered as apposed to mostly non-approvable loan submissions.

Variables such as individual credit items, property type, employment and asset documentation type, occupancy, purchase or refinancing can change the values the program puts out. This allows all possible variables based off the sub-module base values that are pre-loaded independently. Each sub-module has an adjustment template attached to it that can make independent adjustments to values that may vary inside the sub-module. For example, if there are several employment types allowed, they will have different values and rules for each one. So, the investor would complete a template for each employment type to get all of the exact adjustments. When a borrower profile comes through the computerized system 10, the program will automatically compare all the values of that borrower profile and apply the worst downward adjustment to each of the criteria using the lowest loan to value adjustment that was pre-loaded for each of the borrower's profile attributes. The base values are collected during a pre-load and are used in the second part of the program loading process as an “exclusion menu”. The amount of combinations can run into the hundreds and thousands. This pre-loading and exclusion menu process eliminates the need to enter multiple allowed variables or scenarios that normally occur in the mortgage business due to each borrower's situation being different. By using this algorithm, all variables are allowed, except the final values specifically excluded.

In the final step, the investor is shown combinations of the values loaded during the pre-load and can exclude any non-allowable combinations of the base values in the exclusion process. This is necessary because situations may arise where certain base values may not be allowed by the investor in particular combinations. For example, a borrower may come through the program requesting a self-employed, credit tier 3, 3-4 unit property. These may be all allowable values independently according to the base values from the pre-load operation. However, when combined, they are invalid. The investor may have a special requirement, for example, that a self-employed borrower trying to purchase 3-4 units be in credit tier 1 or 2 only. In this case, the value given off base values alone would be invalid for self-employed 3-4 units. However, if the investor allows self-employed borrowers to be in any credit tier, except for when purchasing 3-4 units which require credit tier 1 or 2 only, the investor could not exclude the values using the exclusion menu without excluding other valid values as well. This is because the investor would have to exclude credit tiers 3-6 for self-employed borrowers completely to make sure no 3-4 units would go through. This would invalidate other good values. In these rare occasions, the investor can use the special requirements tool to exclude specific data string values to pinpoint specific values.

After the program base values, exclusions and any special requirements are loaded, the investor needs to make final loan to value adjustments, based off credit tiers. For each sub-module and each value in the sub-module, loan to value adjustments are applied. For example, each employment type is compared to each allowable credit tier and the maximum loan to value is entered. This process is especially important for employment types and property types where credit tier values change constantly. The program then uses the worst downward adjustments when approving loans. For example, if the borrower comes through with a selfemployed, credit tier 3 (maximum greater than 90% loan to value), 3-4 units property (maximum greater than 80% loan to value), the program would automatically take the worst downward loan to value adjustment and return a value of maximum 80% loan to value.

Once this operation is complete, the investor can enter their requirement for other loan uses they may allow such as refinancing or non-occupied purchase and refinance. Initially on the first load, the investor will begin by completing a general questionnaire where they will state the uses allowed for the loan product. The first load they complete will be for owner occupied purchase. If they allow refinancing and the non-owner variables, they will enter those separately one by one. The values usually will only change approximately 5%-20%. Therefore, the program will use a copy save function, after the first load is completed. The idea is to save the investors' work, so they can simply make edits to complete the loading process for the other allowable uses for the program quickly, without the need to do any redundant work. This method of automating the underwriting process should be in the range of 97%-99% accurate without the use of the special requirements tool. The remaining approximate 1%-3% of possible inaccurate values, should be picked up by the investor by using the special requirements tool.

The special requirements tool (not shown) allows the investor to pinpoint, if necessary, particular non-allowed value combinations or variables for very special situations where the base underwriting guidelines and exclusion process cannot deliver a correct value. These combinations are so rare they can be used by the investor when loading a loan program and will override the pre-loaded base values for the program, when necessary. The special requirements tool works as follows. The investor would use a pull-down menu generated from the sub-modules of the investor profile high level. Once a sub-module is chosen, such as employment or property information, a drop-down menu would display all of the field names in the sub-module. The investor chooses their desired criteria type here, for example 3-4 units. The investor can use this menu to gather all necessary values for their data string creation. Next the investor uses a tool menu with values they chose to complete their data strings. The investor can then build a data string value to override the base pre-loaded sub-module values in the program. This tool is used for addressing the 1%-3% of inaccurate values the program may generate solely based upon the pre-load and exclusion process. Here is an example of a possible data string (3-4 units=S/E=greater than score tier 2). This data string would indicate that 3-4 units is OK for self-employed borrowers if their credit tier is tier 1 only. The data string has eliminated credit score tiers 2-6.

This tool could be used in a situation where the investor indicates on a pre-load that self-employed purchasing 3-4 units is OK, but for only credit score tier 1. In this case, the investor would not exclude the property type of 3-4 units because it is allowed with the correct credit score. However, if a lower credit tier is allowed for this borrower type (self-employed for other properties), the program now would not exclude those potential values because they would never have been excluded on the exclusion menu during the pre-load process, because the investor would know they could use the special requirement tool to eliminate this particular value. The value of this tool is it allows investors to keep all other allowable values available, while excluding only specific requested data chains. The odds of this are very low. This tool would be available to override any possible error if the investor could catch it on the program load.

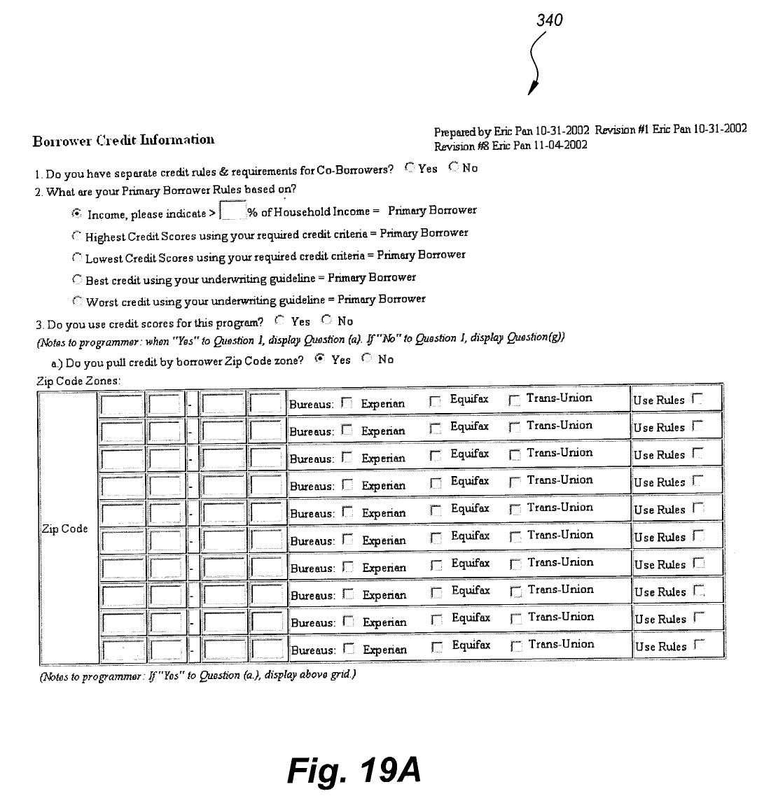

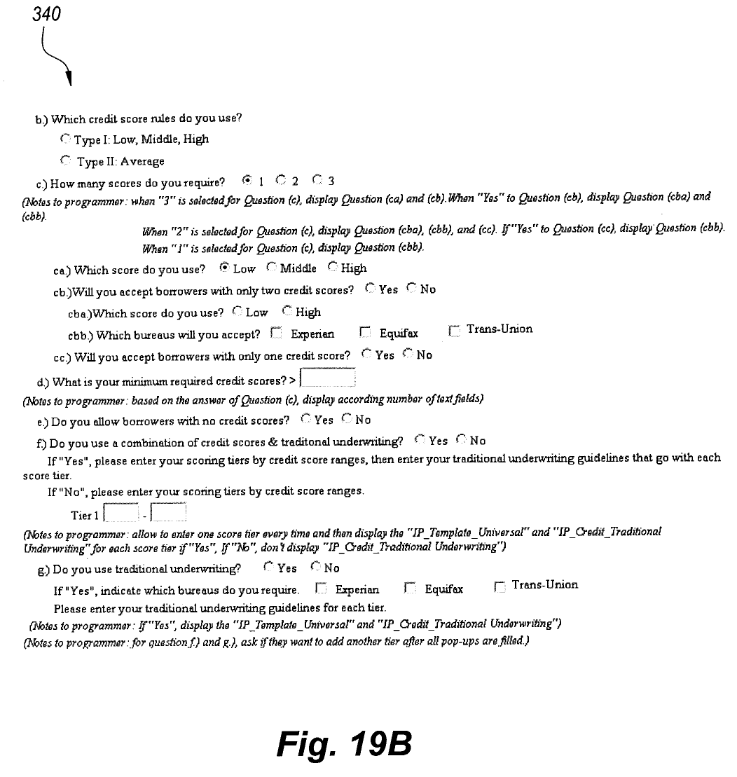

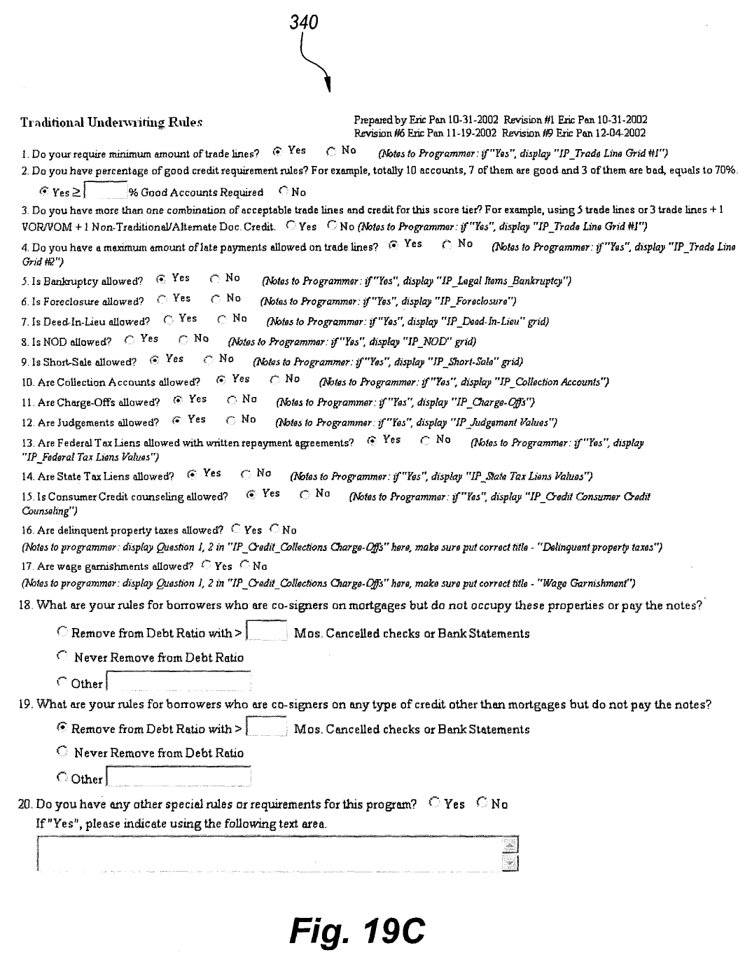

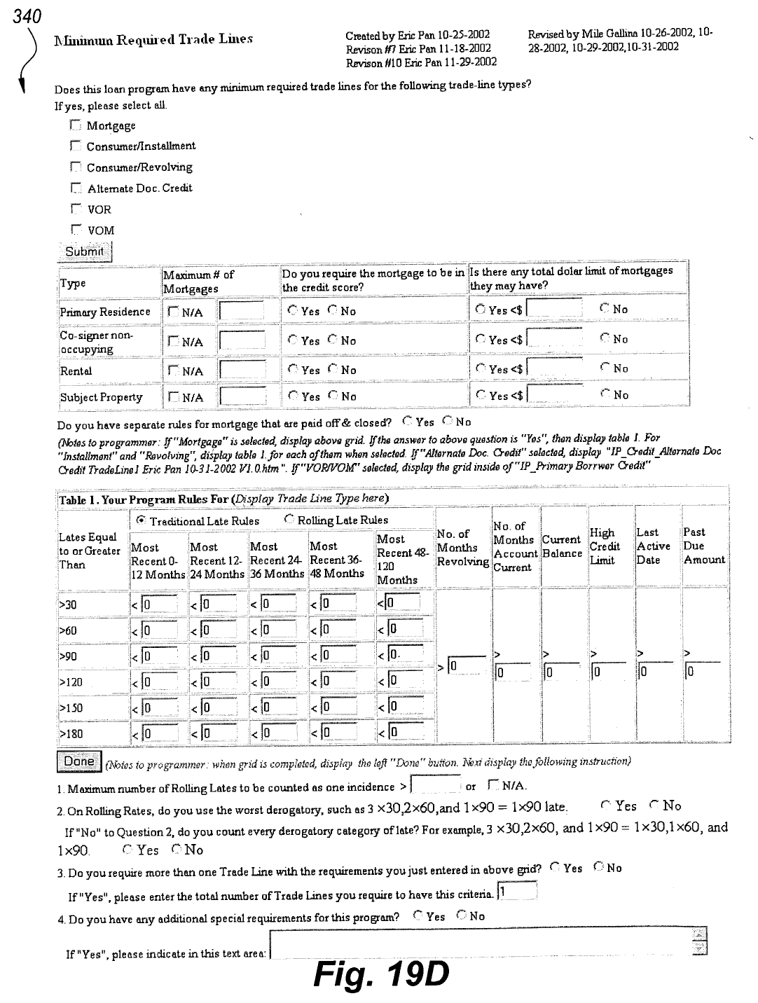

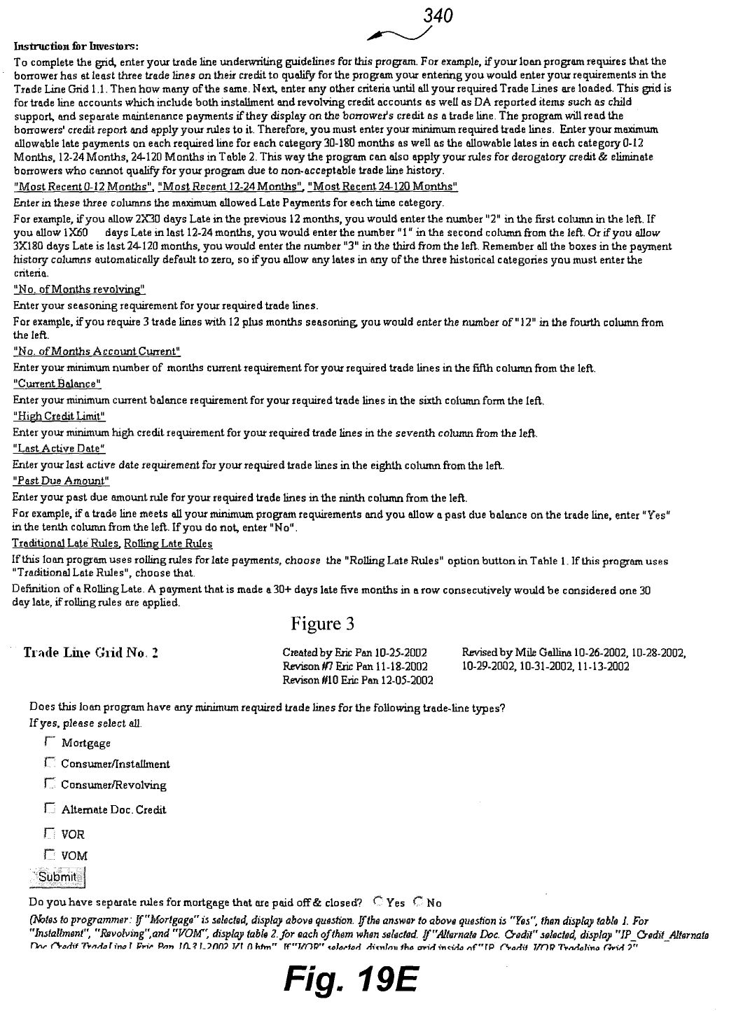

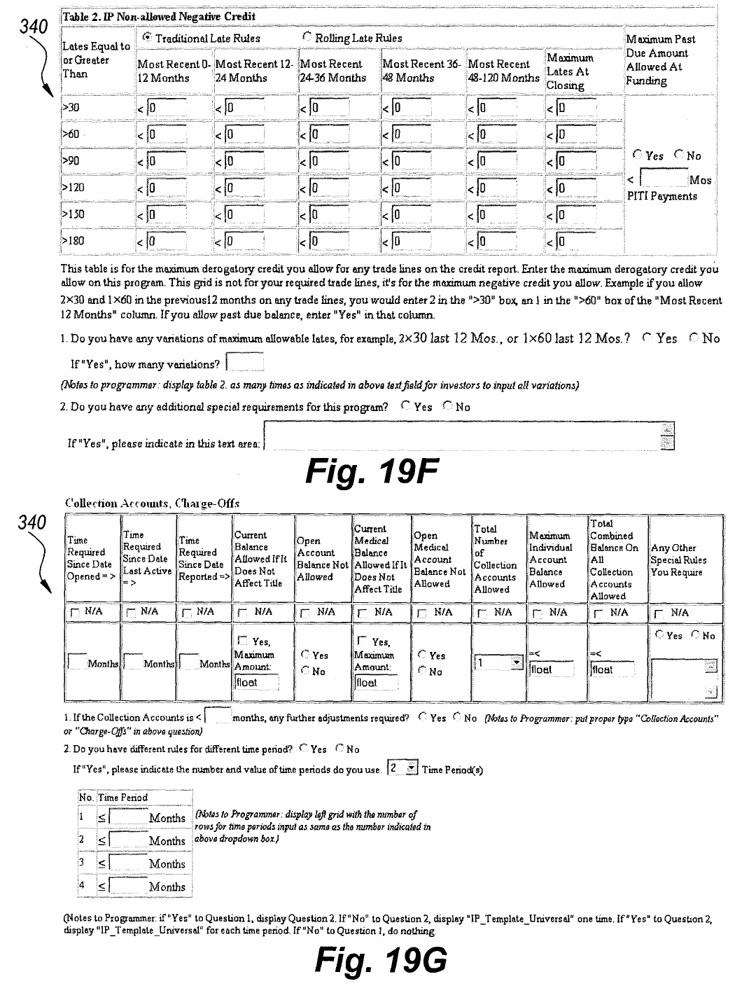

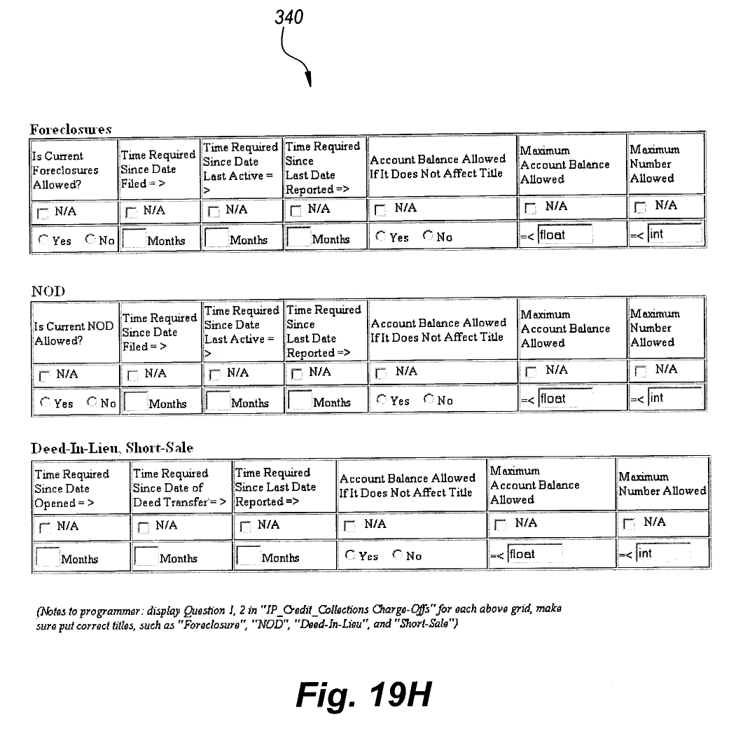

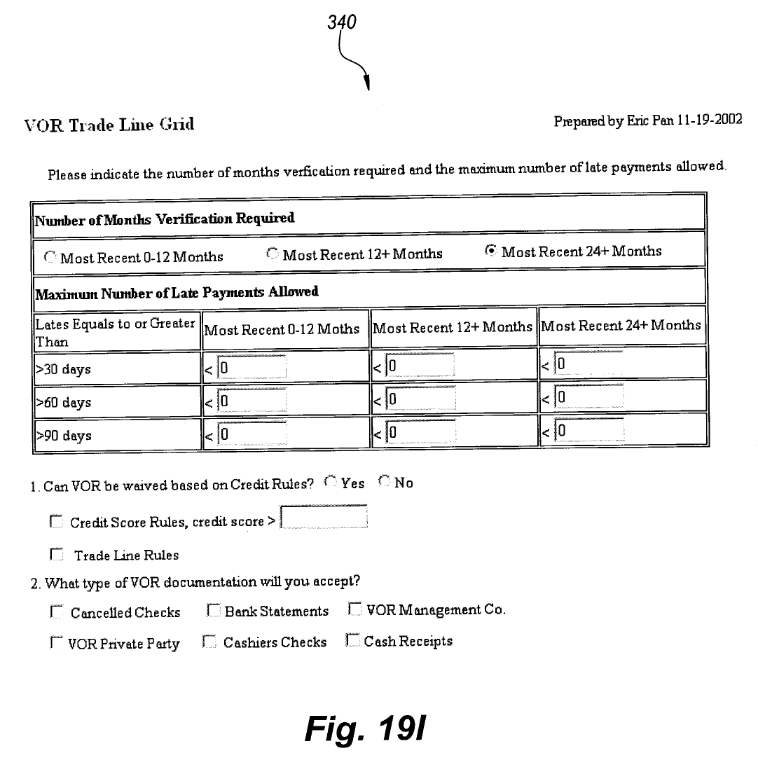

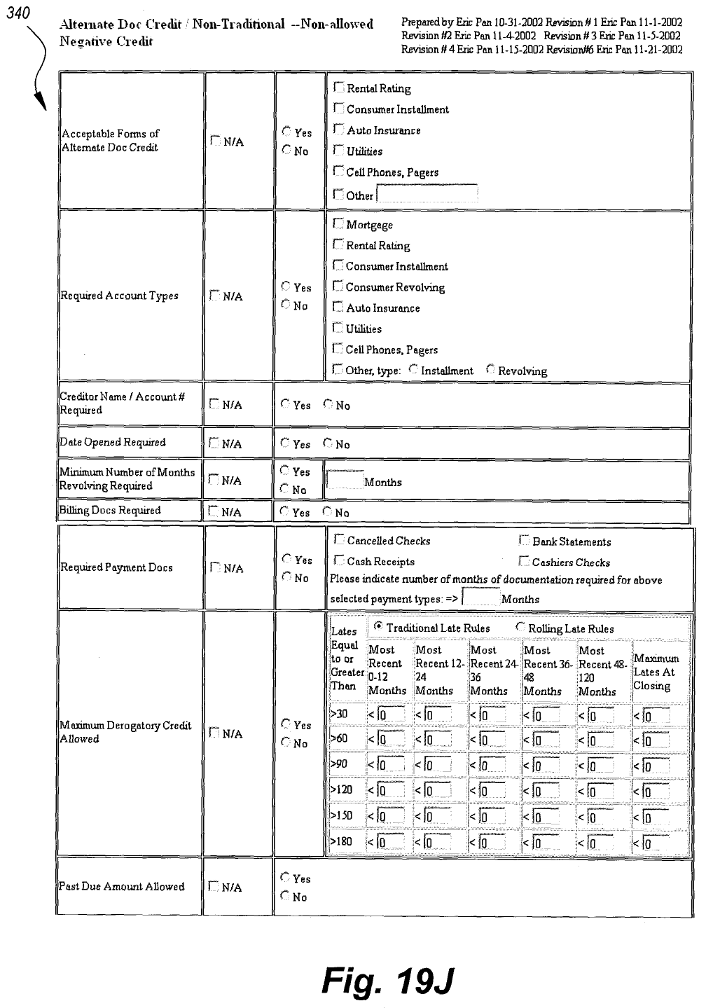

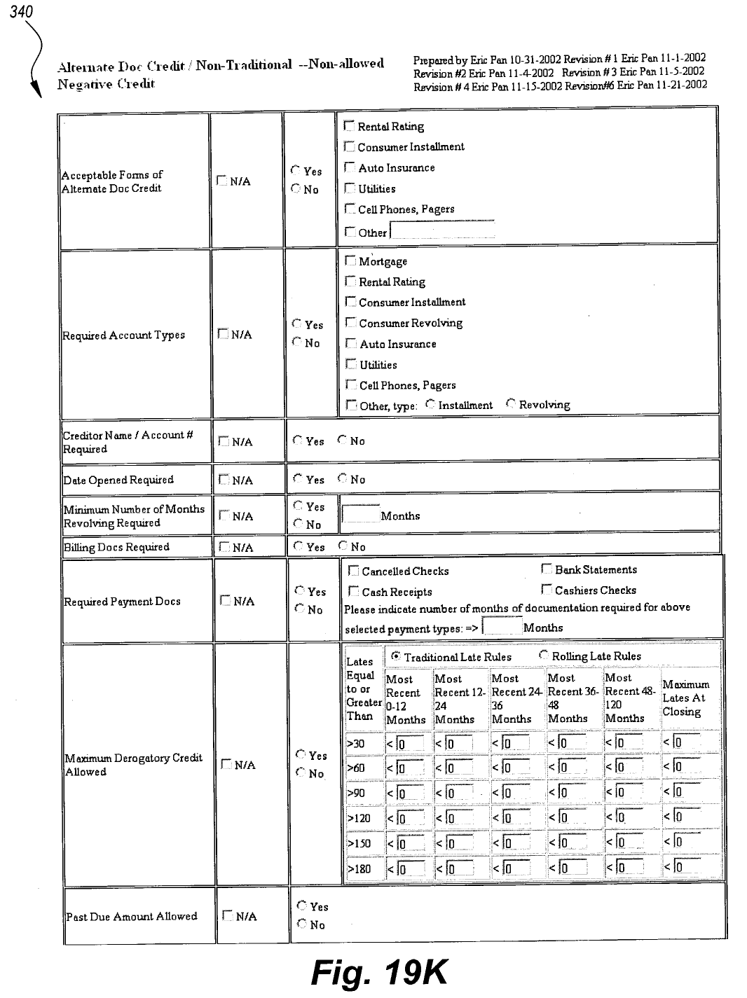

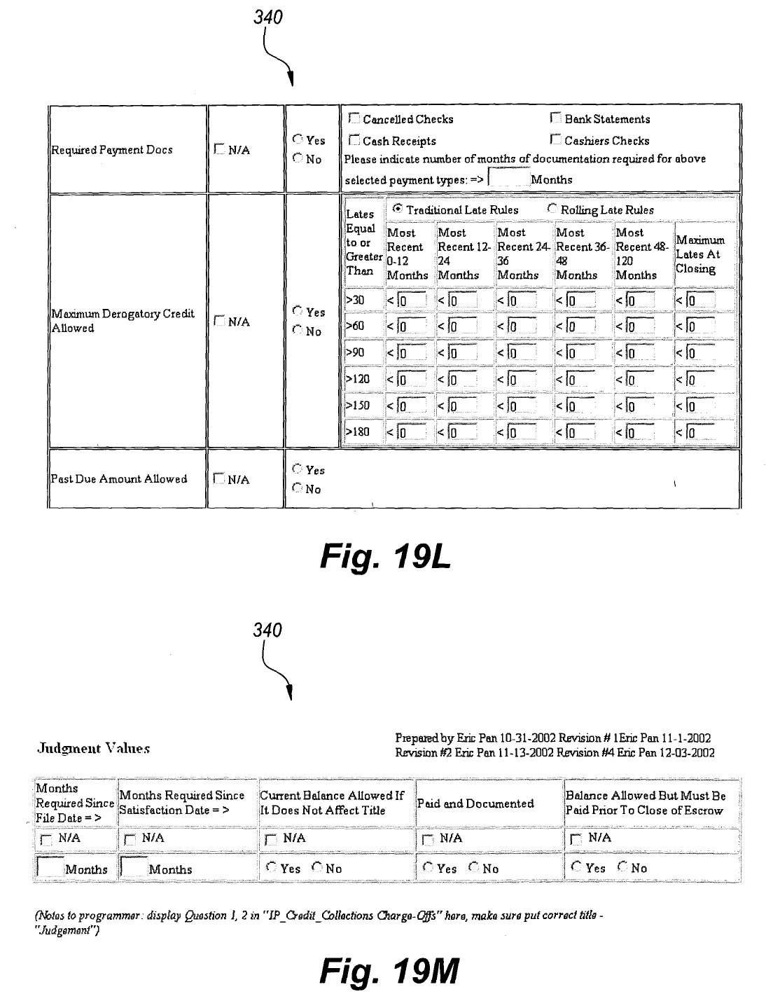

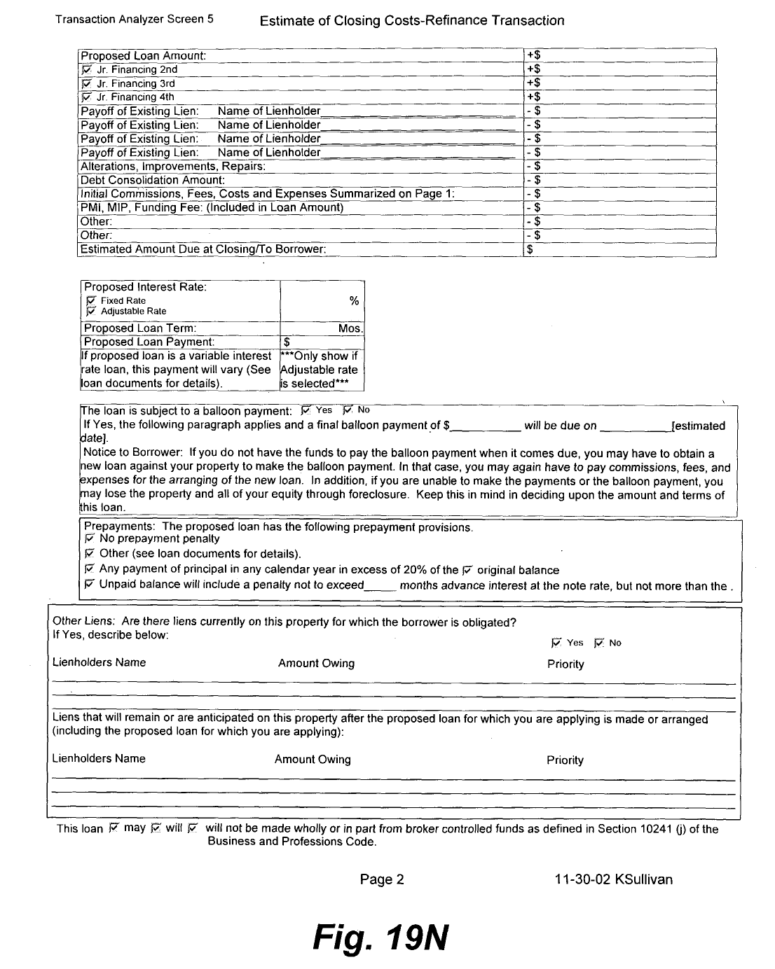

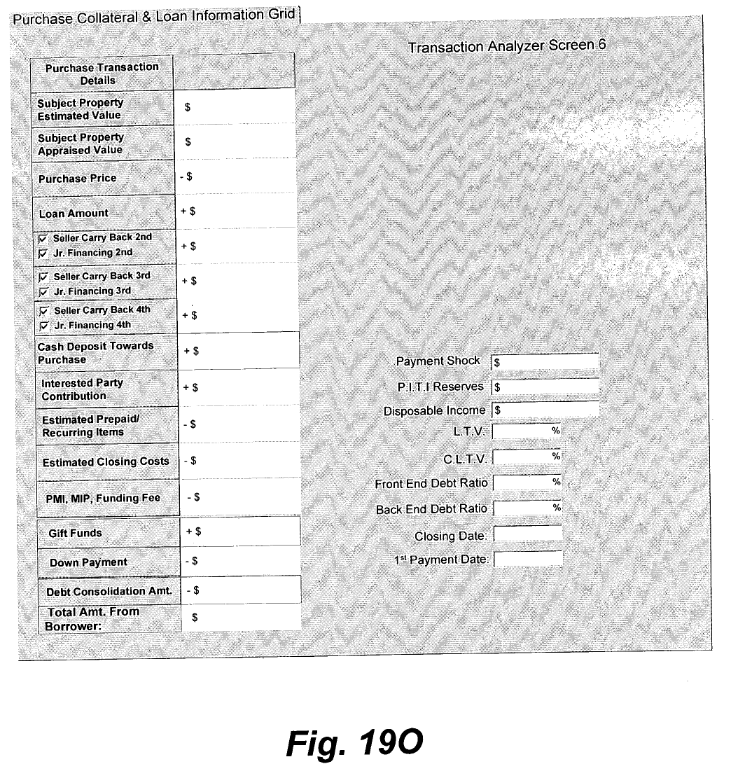

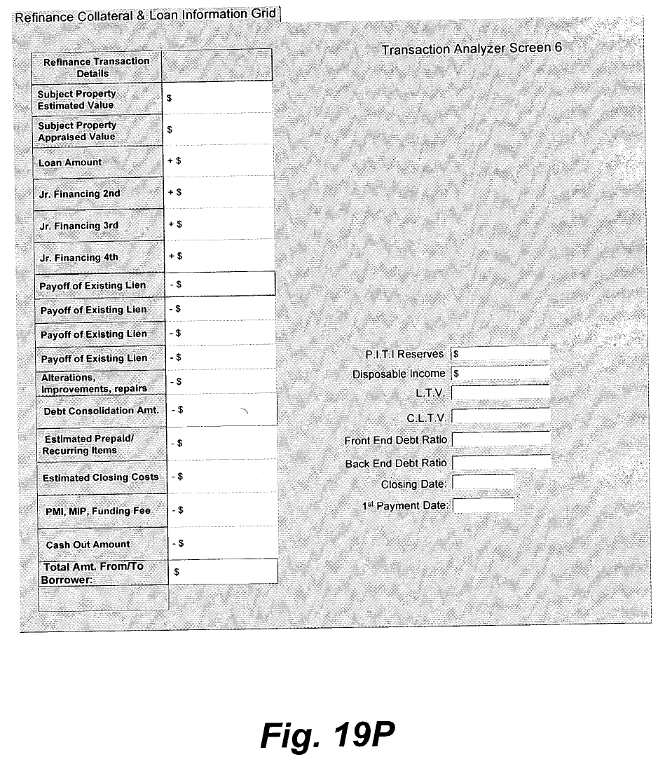

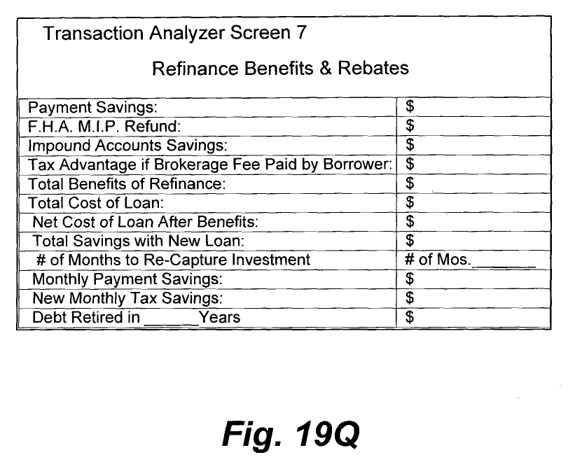

If not, it could be caught by the underwriter on quality control when a borrower comes through and then be corrected. The investor profile sub-modules 340 mirror the questionnaire modules 74 with the exception of the questionnaire module 74 pre-interview sub-module, that is not necessary for the investor requirement. The purpose of the IP sub-modules 340 is to get the investors' rules and requirements for the particular program they are loading. The IP sub-modules 340 are depicted in FIGS. 19A-Q. The rules and requirements for each program vary. In the IP submodules 340, the investor can select from menus and selection boxes and their specific rules and requirements for each submodule. The investor can enter the formulas to calculate income, is credit requirements, property requirements, employment and income requirements and asset requirements. The purpose and benefit of this is to filter possible loan submissions to the investor that have no chance of being approved. This is due to the many variables in the loan business. Many brokers cannot keep track of every variable and often submit paper loan files that cannot be approved. This costs the investor a lot of money to process all the files that cannot be approved. By electronically collecting all investor requirements and then electronically collecting all the borrowers' data and then using this data to match borrowers and investors, costs to originate loans can be cut.

When the investor makes the one time investment of time to load a program, the benefits are seen immediately in a streamlining of their lending operations. Invalid loan submissions can be identified and stopped prior to submission, allowing investor underwriters to underwrite more effectively while increasing their funding ratios. Odds also increase that each loan the investor now receives will be close to a perfect match for their requirements. Furthermore, by being able to view electronic loan applications, the investor saves on the cost of messengers to have files delivered to their locations and the cost of running back-up credit reports on each new submission. Also, money is saved in administrative costs because all the paper loan submissions do not need to be entered into the investors' underwriting Q anymore. The investor can now review complete loan applications over the Web site, then make a lending decision and if the loan cannot be approved and lose only the short time invested to review the application over the Web site. If the loan can be funded, the investor simply notifies the broker via the Web site to send the paper loan file in for loan documents.

One of the more important sub-modules in the computerized system 10 is the credit information sub-module (not shown). This sub-module allows the investor to load their particular credit requirement for each loan program they offer. This technology is called credit valuation logic. It reads the borrower's credit report and then determines if the borrower and investor credit profiles are a match. It looks at every item and value on the credit report just like a human underwriter.

Many investors have multiple special requirements ranging from account balances and maximum allowable credit lines to amount of allowable late payments within certain time periods. The program also allows the investor to load their required credit bureaus and combinations they require of credit scores and traditional underwriting items to make credit decisions (Traditional underwriting is the process of reviewing the items on the credit report as apposed to simply looking at credit scores alone and ignoring the account activity of the items on the credit report.). Many investors use one method or the other or combinations of both. Also, the investor can view this credit data via the Web site, eliminating the need to pay to run credit checks on any potential borrowers. The program has a template attached to each credit value for the investor to make these types of adjustments. The template has all the typical values that the investors usually adjust for credit items.

There are several related modules that are related to the credit evaluation logic. One involves a borrower/co-borrower information module, which allows the investor to outline requirements they may have of the borrower regarding first time buyers or previous homeowners and citizenship or foreign national status. Another module is the property information/purpose of loan information module. In this module, the investor is given menus to load all of his or her property type and special loan use rules and requirements. This can include a property menu, a property use menu, a geographic program rules menu, estate types and loan uses allowed, specialized questions for condominiums or other association controlled properties and specialized junior financing questions. There is also an employment income information sub-module. This sub-module allows the investor to load specialized rules and requirements regarding employment and income information. All allowable income types, documentation and formulas applied to them are in this sub-module. This sub-module has capabilities to take the base borrower data from the QM employment sub-module and apply the formulas and rules given by the investor in the IP employment sub-module (to calculate the income according to the investor's guidelines while excluding any non-allowable income). There is also an asset/liability/housing expense information module. This module allows the investor to load all their rules and requirements regarding assets, liabilities and housing expense. This module also allows for entry of program requirements and formulas. Down payment information, closing costs options and guidelines for tax liens, child support and alimony are also provided.

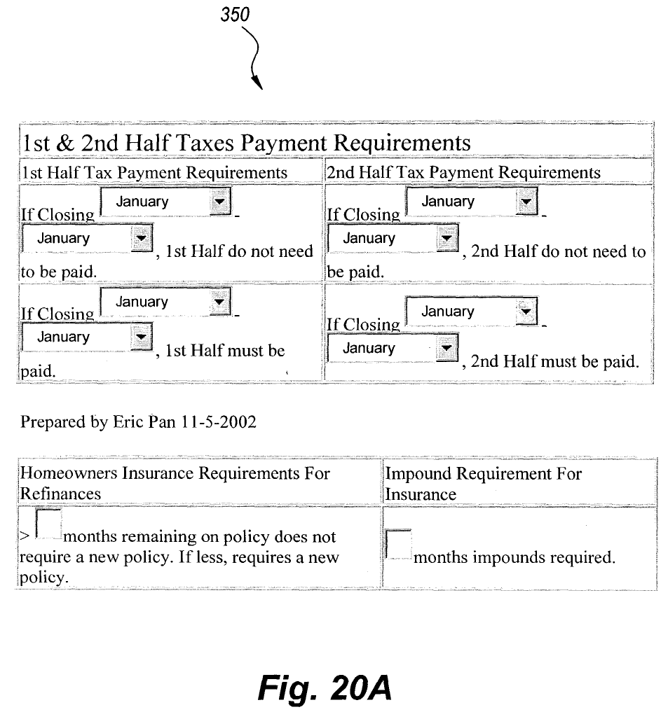

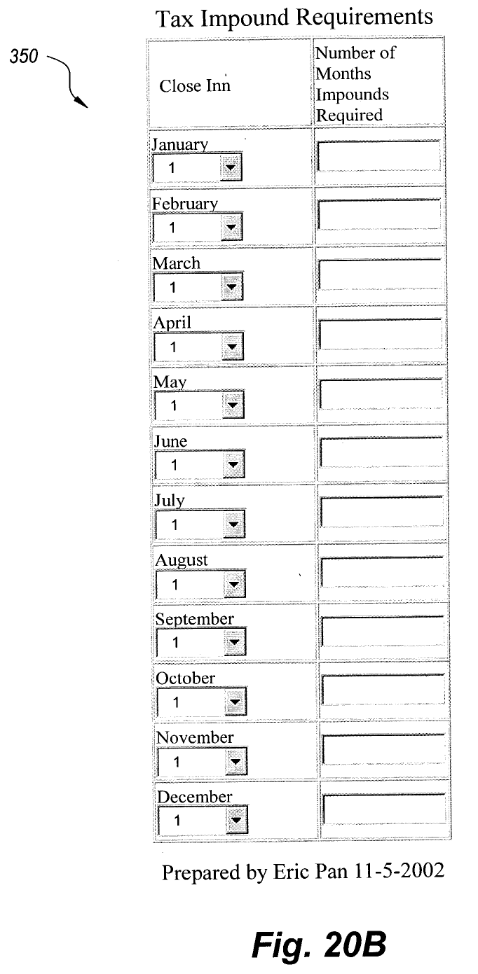

There is also an impound schedule module 350 that allows investors to enter their impound account collection rules for each program they offer, as depicted in FIGS. 20A-20B. The impound schedule module 350 pertains to property taxes, homeowner's insurance and mortgage insurance accounts that are set-up in advance when a loan is originated to pay these upcoming and recurring obligations for the previously mentioned items. Many investors require that these accounts be set-up and many borrowers request them. When these accounts are set-up, the investors will have their own pre-set schedules and formulas for them. It's nearly impossible to make an accurate quote of these fees to a borrower at the time of application, since the broker does not know yet which investor the loan will go to. Through the computerized system 10, the borrower can find an investor that matches his profile at application and the investors' formulas can be populated to the program to generate accurate estimates of the borrowers' impound fees in advance. The impound schedule module takes away the confusion of impound account formulas, speeds up the good faith estimate process, gives borrowers accurate estimates they can plan their closing on and reduces confusion and delays in closing.

One of the benefits of the computerized system 10 is that the mortgage matrix administrators will interface with the California Department of Real Estate and Department of Corporations to verify the valid licensing status of all users prior to them being given any user rights on the computerized system 10.

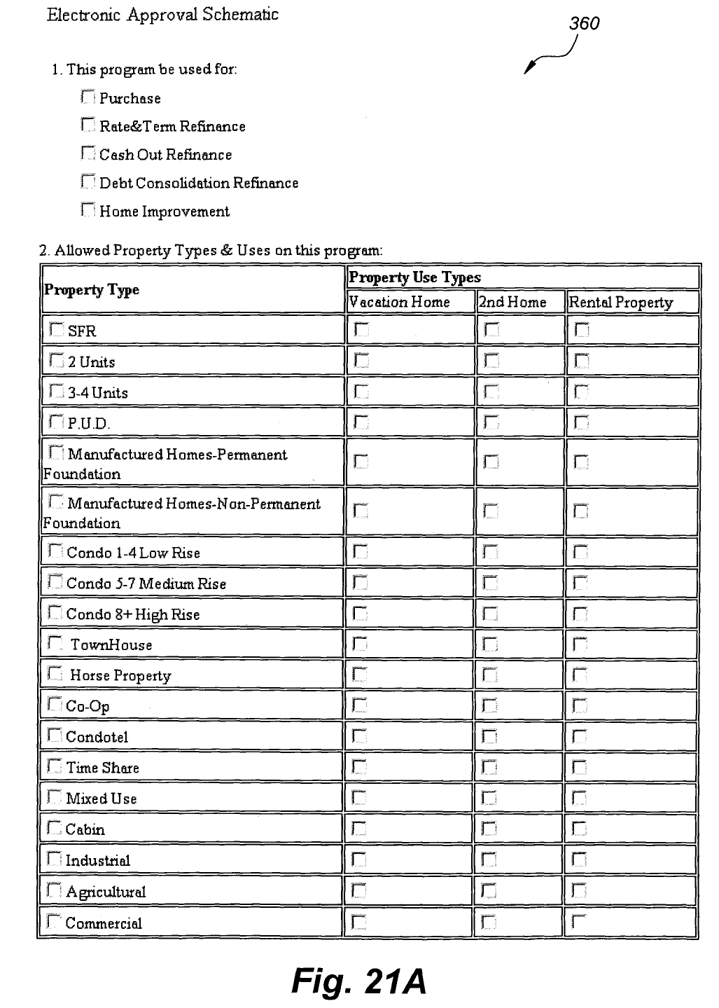

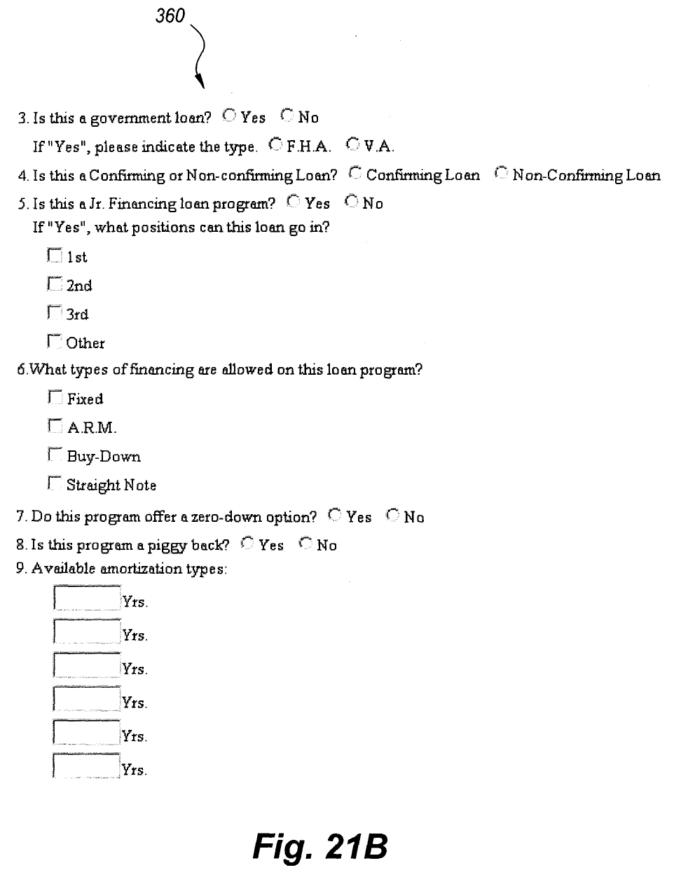

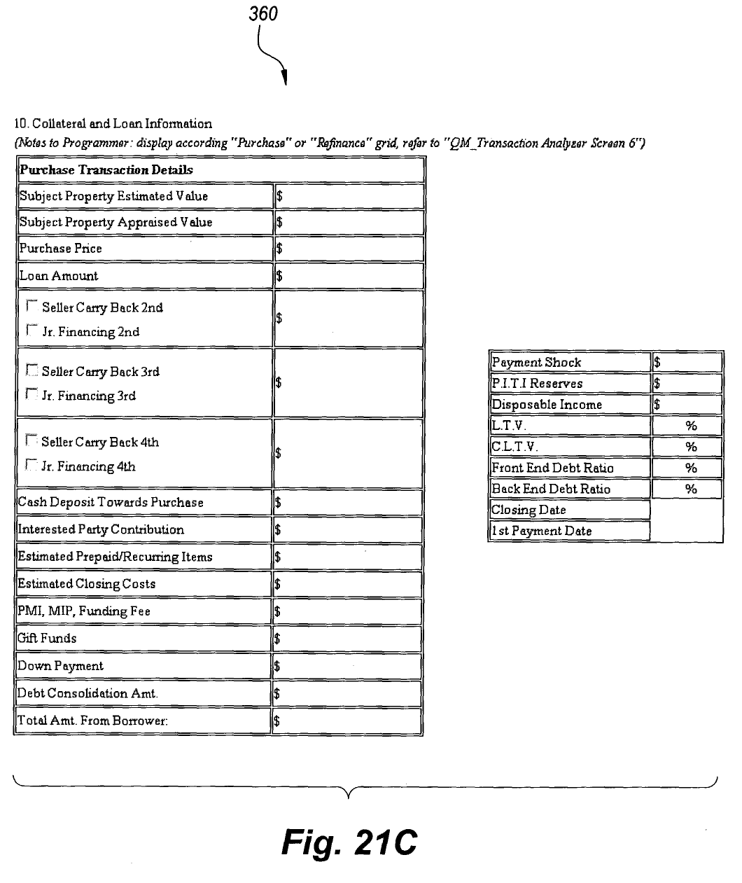

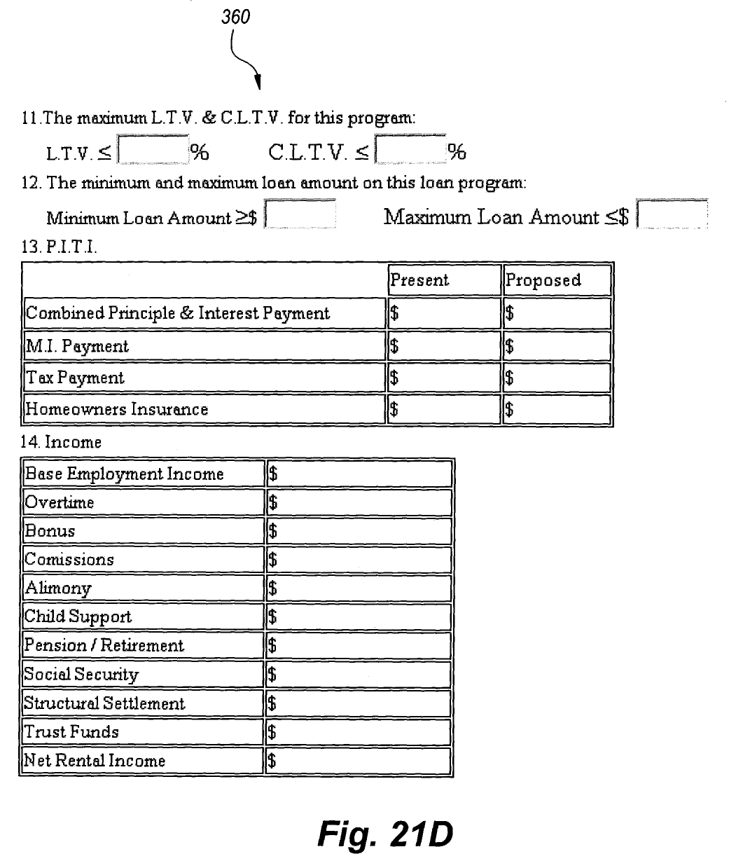

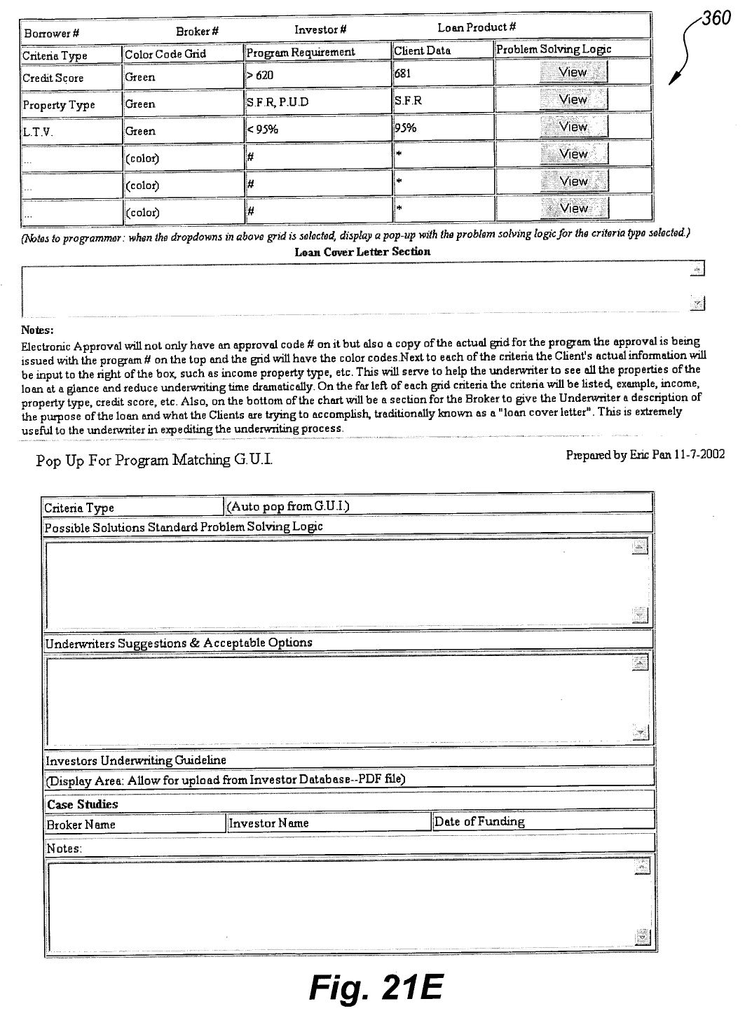

When a borrower has been matched to a loan program, the broker uses an electronic submission and approval document 360 to electronically submit the loan application to the investor. When the investor's underwriter views this document, he or she can view all of the borrower's data along with the investor's pre-loaded underwriting rules and requirements. At the top of the document, the electronic submission and approval document 360 will appear to give the underwriter the base program information. Next, a short version of the transaction analyzer 310 will display the base numbers and debt ratios. Each of the field names on the electronic submission and approval document 360 appear, and next to the field name is the investor program requirement and the borrower data. Each line that is a positive match to investor requirements is lit-up green. Data that is questionable or a close match or may require underwriter review is lit-up in yellow. Data that is a definite non-match is lit-up in red. To the right of these is the problem solving logic, where the investor will have pre-loaded acceptable workarounds to underwriting criteria for the underwriter to review. Below this document is the broker's loan submission sheet. The broker gives the investor a quick overview here of the goals of the borrower and any critical data regarding the loan approval. As depicted in FIGS. 21A-21E, the electronic submission and approval document 360 allows the underwriter to quickly and accurately administer loan approvals and declines, as well as allowing the underwriter to quickly communicate with a broker regarding a loan submission through the Web site.

It is to be understood that the present invention is not limited to the sole embodiment described above, but encompasses any and all embodiments within the scope of the following claims.

I claim:

1. A computerized system for qualifying mortgage loan clients (borrowers), comprising:
at least one server computer having a processor, an area of main memory for executing program code under the direction of the processor, a storage device for storing data and program code and a bus connecting the processor and the storage device;
at least one relational database stored on said storage device;
a data communications device connected to said bus for connecting said server computer to the Internet; and
a Web-based qualifying mortgage loan computer program code stored in said storage device and executing in said main memory under the direction of said processor, the computer program including:
Web server software means for qualifying mortgage loan clients at at least one Web site on the Internet;
means for receiving a client's data from a client through said Web site;
means for requesting client data from a plurality of title companies and a plurality of credit bureaus;
means for indicating which client data has good creditworthiness, average creditworthiness and poor creditworthiness;
means for making a mortgage loan approval attempt using conventional investors and unconventional investors;
means for indicating the type of mortgage loan program desired and indicating if investors' standards are met;
means for indicating best mortgage loan programs and options available; and
means for rejecting of the application of a mortgage loan program and further corrective actions to take.

2. The computerized system according to claim 1, wherein said means for requesting borrower data from a plurality of title companies and a plurality of credit bureaus is requesting client data from server to server over the Internet.

3. The computerized system according to claim 1, wherein said means for requesting borrower data are color-coded to indicate the individual's loan parameter creditworthiness.

4. The computerized system according to claim 1, wherein said computerized system searches borrower and seller public records to confirm client judgments, marriages, child support, liens and Lis Pendens.

5. The computerized system according to claim 1, wherein all borrower data is populated into a matrix questionnaire.

6. The computerized system according to claim 1, wherein all of the borrower data is compared with an investor's program information.

7. The computerized system according to claim 6, wherein a highest percentage of the borrower data must match with investor program information in order to be a successful match.

8. The computerized system according to claim 7, wherein a borrower receives electronic approval and the computerized system prints any investor required documents and the borrower's closing plan.

9. The computerized system according to claim 1, wherein total remaining interest on all revolving and installment debt shows the borrower total savings obtainable with a debt consolidation.

10. The computerized system according to claim 1, wherein said borrower's closing plan can be flexed for longer and shorter escrows.

11. The computerized system according to claim 1, wherein after final investor approval, the broker and the borrower sign any investor required documents, the borrower's closing plan and an electronic approval or drop in a messenger bag for delivery to the final investor.

12. The computerized system according to claim 1, wherein all of the parties involved with the computerized system receive passwords from a transaction coordinator to review progress and input data.

13. The computerized system according to claim 1, where all of the parties involved with the computerized system can download information from the computerized system using a software patch.

14. The computerized system according to claim 1, wherein less than a highest percentage of the borrower data matches with an investor program information in order to be an unsuccessful match.

15. The computerized system according to claim 14, wherein said computerized system gives borrowers with an unsuccessful match reasons for and actions needed to be taken in order to be a successful match.

16. The computerized system according to claim 14, wherein said computerized system is provided with a diary indicating at the correct follow up time the actions needed to be taken to be a successful match.

17. The computerized system according to claim 1, wherein further corrective action includes an outside facilitator company negotiating settlements between a borrower and his creditors.

18. The computerized system according to claim 1, wherein borrowers with an unsuccessful match have their borrower data stored for a later mail and follow-up campaign to move toward loan qualification.

19. The computerized system according to claim 1, wherein borrowers receive letters and brokers are e-mailed from the computerized system to explain the steps involved with the first approval attempt.

20. The computerized system according to claim 19, wherein an automatic default will resubmit an unsuccessful match on a daily basis until a successful match is found.

21. The computerized system according to claim 1, wherein a search engine is provided to search for specific underwriting guidelines in the relational database(s).

22. The computerized system according to claim 1, wherein a search engine is provided to search for case studies in the relational database(s).

23. The computerized system according to claim 1, wherein a follow-up diary and book marketing module is provided.

24. The computerized system according to claim 1, wherein an auto rate lock is provided to automatically lock a rate for a borrower when the rate becomes available.

25. The computerized system according to claim 1, wherein a broker's favorite list is provided to store and select favorite vendors.

26. The computerized system according to claim 1, wherein a borrower profile electronic submission interface is provided to search the relational database(s) for potential borrower matches.

27. The computerized system according to claim 1, wherein a credit functions module is provided to manually override items in a credit report.

28. The computerized system according to claim 1, wherein a loan application has a plurality of sub-modules that will prompt questions that will qualify a borrower for the best possible rate and financial guidelines for a loan.

29. The computerized system according to claim 1, wherein a variety of different principal and rate options are presented for a loan application.

30. The computerized system according to claim 1, wherein a loan application interface is provided to collect and populate data on borrowers from human resources departments, the Internal Revenue Service, banking institutions, the Veterans Administration, the Department of Housing and Urban Development, condo certification companies, public record companies and outside employment verification companies.

31. The computerized system according to claim 1, wherein a borrower will receive only a single merged credit report inquiry while shopping for various loan applications.

32. The computerized system according to claim 1, wherein a borrower's loan application is provided with an electronic signature capability.

33. The computerized system according to claim 1, wherein a crystal report is produced for brokers and borrowers to see what documents and requirements are needed to close their loan application.

34. The computerized system according to claim 1, wherein a built-in program loading logic is provided to match borrower profiles with investor loan programs.

35. The computerized system according to claim 1, wherein a module will automatically compare all of the values of a borrower profile and apply the worst downward adjustment to each loan criteria using the lowest loan to value adjustment that is preloaded for each attribute of the borrower profile.

36. The computerized system according to claim 1, wherein a special requirements-tool is provided to allow investors to keep all other allowable values available while excluding only specific requested data chains.

37. The computerized system according to claim 1, wherein a credit information sub-module is provided to allow an investor to load required credit bureaus and combinations they require of credit scores and traditional underwriting items to make credit decisions.

38. The computerized system according to claim 1, wherein an impound schedule module is provided to enter impound account collection rules.

39. The computerized system according to claim 1, wherein the computerized system will interface with the California Department of Real Estate and Department of Corporations to verify a valid licensing status for all users.

40. A computer program product that includes a medium readable by a processor, the medium having stored thereon a set of instructions for a mortgage loan qualifying system, comprising:
a first sequence of instructions which, when executed by the processor, causes said processor to receive a client's data from the client through said Web site;
a second sequence of instructions which, when executed by the processor, causes said processor to request client data from a plurality of title companies and a plurality of credit bureaus;
a third sequence of instructions which, when executed by the processor, causes processor to indicate which client data has good creditworthiness, average creditworthiness and poor creditworthiness;
a fourth sequence of instructions which, when executed by the processor, causes the processor to make a mortgage loan approval attempt using conventional investors and unconventional investors;
a fifth sequence of instructions which, when executed by the processor, causes the processor to indicate the type of mortgage loan program desired and indicating if investors' standards are met;
a sixth sequence of instructions which, when executed by the processor, causes processor to indicate the best mortgage loan programs and options available; and
a seventh sequence of instructions which, when executed by the processor, causes processor to reject an application of the mortgage loan program and pursue further corrective actions to take.

41. The computer program product according to claim 40, wherein client data with average creditworthiness and poor creditworthiness are provided with underwriting guidelines and case studies to enhance client problem solving.

42. The computer program product according to claim 40, wherein said conventional investors are Fanny Mae, Freddie Mac, Federal Housing Administration (FHA) investors and Veterans Administration (VA) investors.

43. A computer program product according to claim 40, wherein unconventional investors are sub-prime, 100% and “as stated” investors.

44. A computer program product according to claim 40, wherein further action creates dispute letters for incorrect credit information and direct links to credit bureau servers.

45. A computer program product according to claim 40, wherein further corrective action includes providing a signature loan to clear any client bad debt.

46. A computerized method for qualifying mortgage loan clients over the Internet, comprising the steps of:
receiving a client's data from a client through said Web site;
requesting client data from a plurality of title companies and a plurality of credit bureaus;
indicating which client data has good creditworthiness, average creditworthiness and poor creditworthiness;
making a mortgage loan approval attempt using conventional investors;
indicating the type of mortgage loan program desired and indicating if investors' standards are met;
indicating the best mortgage loan programs and options available; and
rejecting an application of the mortgage loan program and pursuing further corrective action to take.

47. A computerized method according to claim 46, wherein said types of mortgage loans are for purchase, refinancing and junior financing.

48. A computerized method according to claim 46, wherein said options include 15, 20, 25 and 30 year terms.

49. A computerized method according to claim 46, wherein broker statistics are kept to track conversion ratios and to indicate areas of performance improvement.

50. A computerized method according to claim 46, wherein exact closing costs are calculated.
